(19) United States
(12) Patent Application Publication
(10) Pub. No.: US 2022/0334991 A1
(43) Pub. Date: Oct. 20, 2022

(54) SOFTWARE-DRIVEN REMAPPING HARDWARE CACHE QUALITY-OF-SERVICE POLICY BASED ON VIRTUAL MACHINE PRIORITY

(71) Applicants: Karthik V Narayanan, Chandler, AZ (US); Rupin H Vakharwala, Hillsboro, OR (US); Michael Prinke, Aloha, OR (US); Raghunathan Srinivasan, Chandler, AZ (US)

(72) Inventors: Karthik V Narayanan, Chandler, AZ (US); Rupin H Vakharwala, Hillsboro, OR (US); Michael Prinke, Aloha, OR (US); Raghunathan Srinivasan, Chandler, AZ (US)

(21) Appl. No.: 17/854,955

(22) Filed: Jun. 30, 2022

(51) Int. Cl. G06F 13/28; G06F 12/10

(52) U.S. Cl. CPC G06F 13/28; G06F 12/10; G06F 2213/28

(57) ABSTRACT

Systems, methods, and devices for software-driven resource reservation of an input/output memory management unit (IOMMU) are provided. A system may include a peripheral device and a processing device. The peripheral device may be accessible to a virtual machine running on the processing device via direct memory access (DMA) that is translated by an IOMMU). The processing device may run the virtual machine and a virtual machine manager. The processing device also includes the IOMMU, which is configurable to reserve a subset of resources of the IOMMU to the virtual machine based on a descriptor provided by the virtual machine manager.

### BACKGROUND

This disclosure relates to setting a remapping hardware cache quality-of-service (QoS) policy of an input/output memory management unit (IOMMU) based on a priority of an application or virtual machine.

Virtualized datacenters are used extensively to provide digital services including web hosting, streaming services, remote computing, and more. Virtualized datacenters are highly scalable. Virtualization allows the creation of multiple simulated environments, operating systems (OS), or dedicated resources from a single, physical hardware system. Virtualization is implemented using software, such as a virtual machine manager (VMM), which is also sometimes referred to as a hypervisor, to manage software known as a “guest” or virtual machine (VM). A virtual machine is software that, when executed on appropriate hardware, creates an environment allowing for the abstraction of an actual physical computer system also referred to as a “host” or “host machine.” In other words, a virtual machine is software that simulates a physical computer system. There may be multiple virtual machines running on a single host machine. Like physical computer systems, each virtual machine may run its own guest operating system (OS) and applications, as well as interact with peripheral devices such as Peripheral Component Interconnect express (PCIe) devices. Each virtual machine can operate independently of other virtual machines and yet use the same hardware resources.

Some virtual machines may interact with peripheral devices using Single Root-Input/Output Virtualization (SR-IOV) or Scalable Input/Output Virtualization (SIOV). The peripheral devices may access memory of the virtual machines using a form of Direct Memory Access (DMA) through Address Translation Service (ATS). Whole peripheral devices or fine-grained device resources can be assigned or shared across multiple virtual machines. From time to time, a virtual machine may have a critical workload to run using a peripheral device. Because the peripheral device may be shared by multiple virtual machines, however, the virtual machine running the critical workload could experience undesirable levels of latency and throughput.

### BRIEF DESCRIPTION OF THE DRAWINGS

Various aspects of this disclosure may be better understood upon reading the following detailed description and upon reference to the drawings in which:

FIG. 1 is a block diagram of a register architecture, in accordance with an embodiment;

FIG. 2A is a block diagram illustrating an in-order pipeline and a register renaming, out-of-order issue/execution pipeline, in accordance with an embodiment;

FIG. 2B is a block diagram illustrating an in-order architecture core and a register renaming, out-of-order issue/execution architecture core to be included in a processor, in accordance with an embodiment;

FIGS. 3A and 3B illustrate a block diagram of a more specific example in-order core architecture, in which a core would be one of several logic blocks (including other cores of the same type and/or different types) in a chip, in accordance with an embodiment;

FIG. 4 is a block diagram of a processor that may have more than one core, may have an integrated memory controller, and may have integrated graphics, in accordance with an embodiment;

FIG. 5 shows a block diagram of a system, in accordance with an embodiment;

FIG. 6 is a block diagram of a first more specific example system, in accordance with an embodiment;

FIG. 7 is a block diagram of a second more specific example system, in accordance with an embodiment;

FIG. 8 is a block diagram of a system on a chip (SoC), in accordance with an embodiment;

FIG. 9 is a block diagram contrasting the use of a software instruction converter to convert binary instructions in a source instruction set to binary instructions in a target instruction set, in accordance with an embodiment;

FIG. 10 is a block diagram illustrating a virtualized datacenter with virtual machines that share access to a peripheral device, in accordance with an embodiment;

FIG. 11 is a block diagram illustrating the virtualized datacenter of FIG. 10, in which a virtual machine running a critical workload has prioritized access to the peripheral device, in accordance with an embodiment;

FIG. 12 is a block diagram of a virtualized datacenter system that includes an input/output memory management unit (IOMMU) that can be set by software running on the virtualized datacenter system to prioritized access to a shared peripheral device, in accordance with an embodiment;

FIG. 13 is a diagram of a capability register of the IOMMU of FIG. 12 to indicate a capability to prioritize access by a virtual machine to a peripheral device, in accordance with an embodiment;

FIG. 14 is a flowchart of a method for setting a priority of a virtual machine in the IOMMU using a software-provided priority descriptor, in accordance with an embodiment;

FIG. 15 is an example resource table of the IOMMU that provides equal access to virtual machines accessing the IOMMU, in accordance with an embodiment;

FIG. 16 is an example resource table of the IOMMU that has reserved some resources for a prioritized virtual machine, in accordance with an embodiment;

FIG. 17 is a flowchart of a method for setting a priority of a virtual machine in the IOMMU using software-provided start priority and stop priority descriptors, in accordance with an embodiment;

FIG. 18 is a diagram of a start priority descriptor to begin prioritizing a virtual machine in the IOMMU, in accordance with an embodiment;

FIG. 19 is a diagram of a stop priority descriptor to end prioritizing a virtual machine in the IOMMU, in accordance with an embodiment;

FIG. 20 is a flow diagram illustrating the use of a start priority descriptor to begin prioritizing a virtual machine in the IOMMU, in accordance with an embodiment;

FIG. 21 is a flow diagram illustrating the use of a stop priority descriptor to begin prioritizing a virtual machine in the IOMMU, in accordance with an embodiment;

FIG. 22 is a diagram of a priority descriptor to indicate a level of prioritization of a virtual machine to the IOMMU, in accordance with an embodiment;

FIG. 23 is a flowchart of a method for setting a level of priority of a virtual machine in the IOMMU using a software-provided priority descriptor, in accordance with an embodiment; and

FIG. 24 is a flow diagram illustrating the use of a priority descriptor to set a level of prioritization of a virtual machine in the IOMM), in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation- specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B. Moreover, this disclosure describes various data structures, such as instructions for an instruction set architecture. These are described as having certain domains (e.g., fields) and corresponding numbers of bits. However, it should be understood that these domains and sizes in bits are meant as examples and are not intended to be exclusive. Indeed, the data structures (e.g., instructions) of this disclosure may take any suitable form.

This disclosure describes systems and methods to prioritize access by an application or a virtual machine to a peripheral device. The approach may be software-driven. An operating system or a virtual machine manager may send a priority descriptor to an input/out memory management unit (IOMMU) that specifies an application or virtual machine to be prioritized. In response, the IOMMU may carry out a quality-of-service (QoS) policy that prioritizes the specified application or virtual machine. The QoS policy may be defined by the IOMMU. Thus, the software that sends the priority descriptor may indicate that the specified application or virtual machine is to be prioritized, but may be agnostic with respect to the particular QoS policy carried out by the IOMMU. As such, many different IOMMU QoS policies and hardware designs may be accommodated. In one example, the priority descriptor may cause the IOMMU to reserve certain hardware resources for the specified application or virtual machine. The specified application or virtual machine thus may be able to access a peripheral device with lower latency or greater throughput.

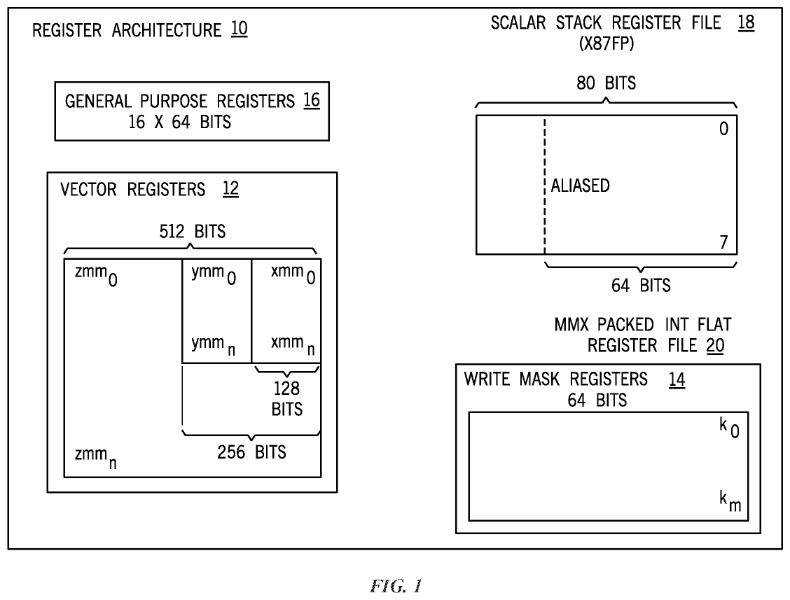

These features may be implemented using any suitable integrated circuit devices that may be used as physical processing devices on which a virtual datacenter may run. The following architecture discussed below with respect to FIGS. 1-9 is intended to represent one example that may be used.

### Register Architecture

FIG. 1 is a block diagram of a register architecture 10, in accordance with an embodiment. In the embodiment illustrated, there are a number (e.g., 32) of vector registers 12 that may be a number (e.g., 512) of bits wide. In the register architecture 10; these registers are referenced as zmm0 through zmmᵢ. The lower order (e.g., 256) bits of the lower n (e.g., 16) zmm registers are overlaid on corresponding registers ymm. The lower order (e.g., 128 bits) of the lower n zmm registers that are also the lower order n bits of the ymm registers are overlaid on corresponding registers xmm.

Write mask registers 14 may include m (e.g., 8) write mask registers (k0 through km), each having a number (e.g., 64) of bits. Additionally or alternatively, at least some of the write mask registers 14 may have a different size (e.g., 16 bits). At least some of the vector mask registers 12 (e.g., k0) are prohibited from being used as a write mask. When such vector mask registers are indicated, a hardwired write mask (e.g., 0xFFFF) is selected and, effectively disabling write masking for that instruction.

General-purpose registers 16 may include a number (e.g., 16) of registers having corresponding bit sizes (e.g., 64) that are used along with x86 addressing modes to address memory operands. These registers may be referenced by the names RAX, RBX, RCX, RDX, RBP, RSI, RDI, RSP, and R8 through R15. Parts (e.g., 32 bits of the registers) of at least some of these registers may be used for modes (e.g., 32-bit mode) that is shorter than the complete length of the registers.

Scalar floating-point stack register file (x87 stack) 18 has an MMX packed integer flat register file 20 is aliased. The x87 stack 18 is an eight-element (or other number of elements) stack used to perform scalar floating-point operations on floating point data using the x87 instruction set extension. The floating-point data may have various levels of precision (e.g., 16, 32, 64, 80, or more bits). The MMX packed integer flat register files 20 are used to perform operations on 64-bit packed integer data, as well as to hold operands for some operations performed between the MMX packed integer flat register files 20 and the XMM registers.

Alternative embodiments may use wider or narrower registers. Additionally, alternative embodiments may use more, less, or different register files and registers.

### Core Architectures, Processors, and Computer Architectures

Processor cores may be implemented in different ways, for different purposes, and in different processors. For instance, implementations of such cores may include: 1) a general purpose in-order core suitable for general-purpose computing; 2) a high performance general purpose out-of-order core suitable for general-purpose computing; 3) a special purpose core suitable for primarily for graphics and/or scientific (throughput) computing. Implementations of different processors may include: 1) a central processing unit (CPU) including one or more general purpose in-order cores suitable for general-purpose computing and/or one or more general purpose out-of-order cores suitable for general-purpose computing; and 2) a coprocessor including one or more special purpose cores primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

### In-Order and Out-of-Order Core Architecture

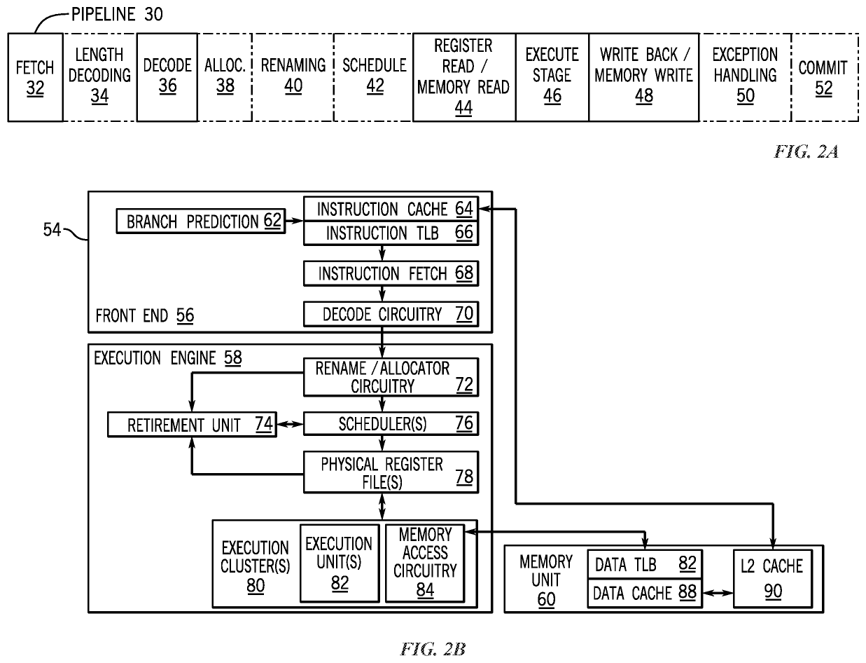

FIG. 2A is a block diagram illustrating an in-order pipeline and a register renaming, out-of-order issue/execution pipeline according to an embodiment of the disclosure. FIG. 2B is a block diagram illustrating both an embodiment of an in-order architecture core and an example register renaming, out-of-order issue/execution architecture core to be included in a processor according to embodiments. The solid lined boxes in FIGS. 2A and 2B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 2A, a pipeline 30 in the processor includes a fetch stage 32, a length decode stage 34, a decode stage 36, an allocation stage 38, a renaming stage 40, a scheduling (also known as a dispatch or issue) stage 42, a register read/memory read stage 44, an execute stage 46, a write back/memory write stage 48, an exception handling stage 50, and a commit stage 52.

FIG. 2B shows a processor core 54 including a front-end unit 56 coupled to an execution engine unit 58, and both are coupled to a memory unit 60. The processor core 54 may be a reduced instruction set computing (RISC) core, a complex instruction set computing (CISC) core, a very long instruction word (VLIW) core, or a hybrid or alternative core type. As yet another option, the processor core 54 may be a special-purpose core, such as, for example, a network or communication core, compression engine, coprocessor core, general purpose computing graphics processing unit (GPGPU) core, graphics core, or the like.

The front-end unit 56 includes a branch prediction unit 62 coupled to an instruction cache unit 64 that is coupled to an instruction translation lookaside buffer (TLB) 66. The TLB 66 is coupled to an instruction fetch unit 68. The instruction fetch unit 68 is coupled to a decode circuitry 70. The decode circuitry 70 (or decoder) may decode instructions and generate as an output one or more micro-operations, micro-code entry points, microinstructions, other instructions, or other control signals, which are decoded from, or which otherwise reflect, or are derived from, the original instructions. The decode circuitry 70 may be implemented using various different mechanisms. Examples of suitable mechanisms include, but are not limited to, look-up tables, hardware implementations, programmable logic arrays (PLAs), microcode read only memories (ROMs), etc. The processor core 54 may include a microcode ROM or other medium that stores microcode for macroinstructions (e.g., in decode circuitry 70 or otherwise within the front-end unit 56). The decode circuitry 70 is coupled to a rename/allocator unit 72 in the execution engine unit 58.

The execution engine unit 58 includes a rename/allocator unit 72 coupled to a retirement unit 74 and a set of one or more scheduler unit(s) 76. The scheduler unit(s) 76 represents any number of different schedulers, including reservations stations, central instruction window, etc. The scheduler unit(s) 76 is coupled to physical register file(s) unit(s) 78. Each of the physical register file(s) unit(s) 78 represents one or more physical register files storing one or more different data types, such as scalar integers, scalar floating points, packed integers, packed floating points, vector integers, vector floating points, statuses (e.g., an instruction pointer that is the address of the next instruction to be executed), etc. In one embodiment, the physical register file(s) unit(s) 78 includes the vector registers 12, the write mask registers 14, and/or the x87 stack 18. These register units may provide architectural vector registers, vector mask registers, and general-purpose registers. The physical register file(s) unit(s) 78 is overlapped by the retirement unit 74 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.).

The retirement unit 74 and the physical register file(s) unit(s) 78 are coupled to an execution cluster(s) 80. The execution cluster(s) 80 includes a set of one or more execution units 82 and a set of one or more memory access circuitries 84. The execution units 82 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform multiple different functions. The scheduler unit(s) 76, physical register file(s) unit(s) 78, and execution cluster(s) 80 are shown as being singular or plural because some processor cores 54 create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster. In the case of a separate memory access pipeline, a processor core 54 for the separate memory access pipeline is the only the execution cluster 80 that has the memory access circuitry 84). It should also be understood that where separate pipelines are used, one or more of these pipelines may be out-of-order issue/execution and the rest perform in-order execution.

The set of memory access circuitry 84 is coupled to the memory unit 60. The memory unit 60 includes a data TLB unit 86 coupled to a data cache unit 88 coupled to a level 2 (L2) cache unit 90. The memory access circuitry 84 may include a load unit, a store address unit, and a store data unit, each of which is coupled to the data TLB unit 86 in the memory unit 60. The instruction cache unit 64 is further coupled to the level 2 (L2) cache unit 90 in the memory unit 60. The L2 cache unit 90 is coupled to one or more other levels of caches and/or to a main memory.

By way of example, the register renaming, out-of-order issue/execution core architecture may implement the pipeline 30 as follows: 1) the instruction fetch unit 68 performs the fetch and length decoding stages 32 and 34 of the pipeline 30; 2) the decode circuitry 70 performs the decode stage 36 of the pipeline 30; 3) the rename/allocator unit 72 performs the allocation stage 38 and renaming stage 40 of the pipeline; 4) the scheduler unit(s) 76 performs the schedule stage 42 of the pipeline 30; 5) the physical register file(s) unit(s) 78 and the memory unit 60 perform the register read/memory read stage 44 of the pipeline 30; the execution cluster 80 performs the execute stage 46 of the pipeline 30; 6) the memory unit 60 and the physical register file(s) unit(s) 78 perform the write back/memory write stage 48 of the pipeline 30; 7) various units may be involved in the exception handling stage 50 of the pipeline; and/or 8) the retirement unit 74 and the physical register file(s) unit(s) 78 perform the commit stage 52 of the pipeline 30.

The processor core 54 may support one or more instructions sets, such as an x86 instruction set (with or without additional extensions for newer versions); a MIPS instruction set of MIPS Technologies of Sunnyvale, Calif.; an ARM instruction set (with optional additional extensions such as NEON) of ARM Holdings of Sunnyvale, Calif.). Additionally or alternatively, the processor core 54 includes logic to support a packed data instruction set extension (e.g., AVX1, AVX2), thereby allowing the operations used by multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof, such as a time-sliced fetching and decoding and simultaneous multithreading in INTEL® Hyperthreading technology.

While register renaming is described in the context of out-of-order execution, register renaming may be used in an in-order architecture. While the illustrated embodiment of the processor also includes a separate instruction cache unit 64, a separate data cache unit 88, and a shared L2 cache unit 90, some processors may have a single internal cache for both instructions and data, such as, for example, a Level 1 (L1) internal cache, or multiple levels of the internal cache. In some embodiments, the processor may include a combination of an internal cache and an external cache that is external to the processor core 54 and/or the processor. Alternatively, some processors may use a cache that is external to the processor core 54 and/or the processor.

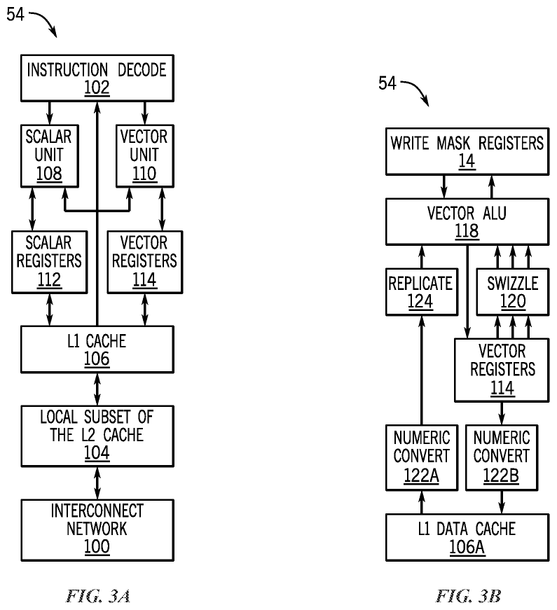

FIGS. 3A and 3B illustrate more detailed block diagrams of an in-order core architecture. The processor core 54 includes one or more logic blocks (including other cores of the same type and/or different types) in a chip. The logic blocks communicate through a high-bandwidth interconnect network (e.g., a ring network) with some fixed function logic, memory I/O interfaces, and other I/O logic, depending on the application.

FIG. 3A is a block diagram of a single processor core 54, along with its connection to an on-die interconnect network 100 and with its local subset of the Level 2 (L2) cache 104, according to embodiments of the disclosure. In one embodiment, an instruction decoder 102 supports the x86 instruction set with a packed data instruction set extension. An L1 cache 106 allows low-latency accesses to cache memory into the scalar and vector units. While in one embodiment (to simplify the design), a scalar unit 108 and a vector unit 110 use separate register sets (respectively, scalar registers 112 (e.g., x87 stack 18) and vector registers 114 (e.g., vector registers 12) and data transferred between them is written to memory and then read back in from a level 1 (L1) cache 106, alternative embodiments of the disclosure may use a different approach (e.g., use a single register set or include a communication path that allow data to be transferred between the two register files without being written and read back).

The local subset of the L2 cache 104 is part of a global L2 cache unit 90 that is divided into separate local subsets, one per processor core. Each processor core 54 has a direct access path to its own local subset of the L2 cache 104. Data read by a processor core 54 is stored in its L2 cache 104 subset and can be accessed quickly, in parallel with other processor cores 54 accessing their own local L2 cache subsets. Data written by a processor core 54 is stored in its own L2 cache 104 subset and is flushed from other subsets, if necessary. The interconnection network 100 ensures coherency for shared data. The interconnection network 100 is bi-directional to allow agents such as processor cores, L2 caches, and other logic blocks to communicate with each other within the chip. Each data-path may have a number (e.g., 1012) of bits in width per direction.

FIG. 3B is an expanded view of part of the processor core in FIG. 3A according to embodiments of the disclosure. FIG. 3B includes an L1 data cache 106A part of the L1 cache 106, as well as more detail regarding the vector unit 110 and the vector registers 114. Specifically, the vector unit 110 may be a vector processing unit (VPU) (e.g., a vector arithmetic logic unit (ALU) 118) that executes one or more of integer, single-precision float, and double-precision float instructions. The VPU supports swizzling the register inputs with swizzle unit 120, numeric conversion with numeric convert units 122A and 122B, and replication with replication unit 124 on the memory input. The write mask registers 14 allow predicating resulting vector writes.

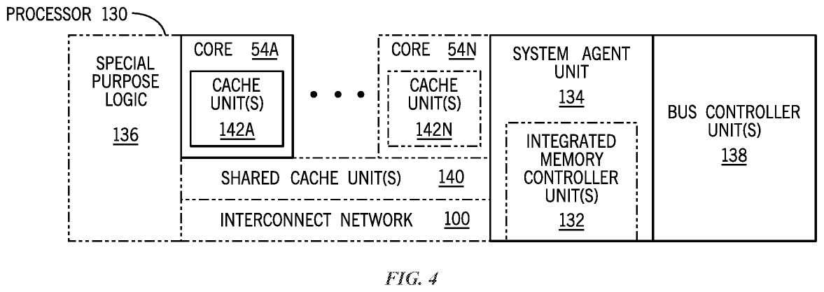

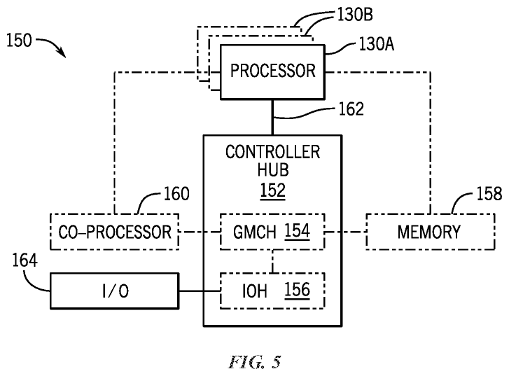

FIG. 4 is a block diagram of a processor 130 that may have more than one processor core 54, may have an integrated memory controller unit(s) 132, and may have integrated graphics according to embodiments of the disclosure. The solid lined boxes in FIG. 4 illustrate a processor 130 with a single core 54A, a system agent unit 134, a set of one or more bus controller unit(s) 138, while the optional addition of the dashed lined boxes illustrates the processor 130 with multiple cores 54A-N, a set of one or more integrated memory controller unit(s) 132 in the system agent unit 134, and a special purpose logic 136.

Thus, different implementations of the processor 130 may include: 1) a CPU with the special purpose logic 136 being integrated graphics and/or scientific (throughput) logic (which may include one or more cores), and the cores 54A-N being one or more general purpose cores (e.g., general purpose in-order cores, general purpose out-of-order cores, or a combination thereof); 2) a coprocessor with the cores 54A-N being a relatively large number of special purpose cores intended primarily for graphics and/or scientific (throughput); and 3) a coprocessor with the cores 54A-N being a relatively large number of general purpose in-order cores. Thus, the processor 130 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), an embedded processor, or the like. The processor 130 may be implemented on one or more chips. The processor 130 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

The memory hierarchy includes one or more levels of cache within the cores, a set or one or more shared cache units 140, and external memory (not shown) coupled to the set of integrated memory controller unit(s) 132. The set of shared cache units 140 may include one or more mid-level caches, such as level 2 (L2), level 3 (L3), level 4 (L4), or other levels of cache, a last level cache (LLC), and/or combinations thereof. While a ring-based interconnect network 100 may interconnect the integrated graphics logic 136 (integrated graphics logic 136 is an example of and is also referred to herein as special purpose logic 136), the set of shared cache units 140, and/or the system agent unit 134/integrated memory controller unit(s) 132 may use any number of known techniques for interconnecting such units. For example, coherency may be maintained between one or more cache units 142A-N and cores 54A-N.

In some embodiments, one or more of the cores 54A-N are capable of multi-threading. The system agent unit 134 includes those components coordinating and operating cores 54A-N. The system agent unit 134 may include, for example, a power control unit (PCU) and a display unit. The PCU may be or may include logic and components used to regulate the power state of the cores 54A-N and the integrated graphics logic 136. The display unit is used to drive one or more externally connected displays.

The cores 54A-N may be homogenous or heterogeneous in terms of architecture instruction set. That is, two or more of the cores 54A-N may be capable of execution of the same instruction set, while others may be capable of executing only a subset of a single instruction set or a different instruction set.

### Computer Architecture

FIGS. 5-8 are block diagrams of embodiments of computer architectures. These architectures may be suitable for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices. In general, a wide variety of systems or electronic devices capable of incorporating the processor 130 and/or other execution logic.

Referring now to FIG. 5, shown is a block diagram of a system 150 in accordance with an embodiment. The system 150 may include one or more processors 130A, 130B that is coupled to a controller hub 152. The controller hub 152 may include a graphics memory controller hub (GMCH) 154 and an Input/Output Hub (IOH) 156 (which may be on separate chips); the GMCH 154 includes memory and graphics controllers to which are coupled memory 158 and a coprocessor 160; the IOH 156 couples input/output (I/O) devices 164 to the GMCH 154. Alternatively, one or both of the memory and graphics controllers are integrated within the processor 130 (as described herein), the memory 158 and the coprocessor 160 are coupled to (e.g., directly to) the processor 130A, and the controller hub 152 in a single chip with the IOH 156.

The optional nature of an additional processor 130B is denoted in FIG. 5 with broken lines. Each processor 130A, 130B may include one or more of the processor cores 54 described herein and may be some version of the processor 130.

The memory 158 may be, for example, dynamic random-access memory (DRAM), phase change memory (PCM), or a combination thereof. For at least one embodiment, the controller hub 152 communicates with the processor(s) 130A, 130B via a multi-drop bus, such as a frontside bus (FSB), point-to-point interface such as QuickPath Interconnect (QPI), or similar connection 162.

In one embodiment, the coprocessor 160 is a special-purpose processor, such as, for example, a high-throughput MIC processor, a network or communication processor, a compression engine, a graphics processor, a GPGPU, an embedded processor, or the like. In an embodiment, the controller hub 152 may include an integrated graphics accelerator.

There can be a variety of differences between the physical resources of the processors 130A, 130B in terms of a spectrum of metrics of merit including architectural, microarchitectural, thermal, power consumption characteristics, and the like.

In some embodiments, the processor 130A executes instructions that control data processing operations of a general type. Embedded within the instructions may be coprocessor instructions. The processor 130A recognizes these coprocessor instructions as being of a type that should be executed by the attached coprocessor 160. Accordingly, the processor 130A issues these coprocessor instructions (or control signals representing coprocessor instructions) on a coprocessor bus or other interconnect, to the coprocessor 160. The coprocessor 160 accepts and executes the received coprocessor instructions.

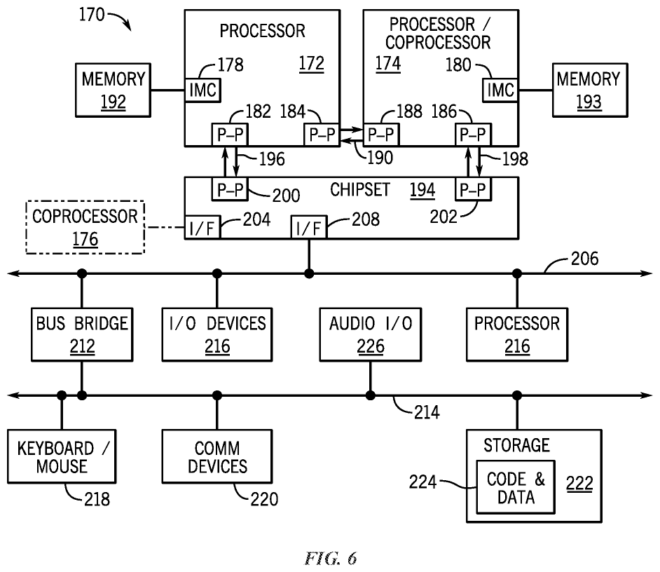

Referring now to FIG. 6, shown is a more detailed block diagram of a multiprocessor system 170 in accordance with an embodiment. As shown in FIG. 6, the multiprocessor system 170 is a point-to-point interconnect system, and includes a processor 172 and a processor 174 coupled via a point-to-point interface 190. Each of processors 172 and 174 may be some version of the processor 130. In one embodiment of the disclosure, processors 172 and 174 are respectively processors 130A and 130B, while coprocessor 176 is coprocessor 160. In another embodiment, processors 172 and 174 are respectively processor 130A and coprocessor 160.

Processors 172 and 174 are shown including integrated memory controller (IMC) units 178 and 180, respectively. The processor 172 also includes point-to-point (P-P) interfaces 182 and 184 as part of its bus controller units. Similarly, the processor 174 includes P-P interfaces 186 and 188. The processors 172, 174 may exchange information via a point-to-point interface 190 using P-P interfaces 184, 188. As shown in FIG. 6, IMCs 178 and 180 couple the processors to respective memories, namely a memory 192 and a memory 193 that may be different portions of main memory locally attached to the respective processors 172, 174.

Processors 172, 174 may each exchange information with a chipset 194 via individual P-P interfaces 196, 198 using point-to-point interfaces 182, 200, 186, 202. Chipset 194 may optionally exchange information with the coprocessor 176 via a high-performance interface 204. In an embodiment, the coprocessor 176 is a special-purpose processor, such as, for example, a high-throughput MIC processor, a network or communication processor, a compression engine, a graphics processor, a GPGPU, an embedded processor, or the like.

A shared cache (not shown) may be included in either processor 172 or 174 or outside of both processors 172 or 174 that is connected with the processors 172, 174 via respective P-P interconnects such that either or both processors' local cache information may be stored in the shared cache if a respective processor is placed into a low power mode.

The chipset 194 may be coupled to a first bus 206 via an interface 208. In an embodiment, the first bus 206 may be a Peripheral Component Interconnect (PCI) bus or a bus such as a PCI Express bus or another third generation I/O interconnect bus, although the scope of the present disclosure is not so limited.

As shown in FIG. 6, various I/O devices 210 may be coupled to first bus 206, along with a bus bridge 212 that couples the first bus 206 to a second bus 214. In an embodiment, one or more additional processor(s) 216, such as coprocessors, high-throughput MIC processors, GPGPUs, accelerators (such as, e.g., graphics accelerators or digital signal processing (DSP) units), field programmable gate arrays, or any other processors, are coupled to the first bus 206. In an embodiment, the second bus 214 may be a low pin count (LPC) bus. Various devices may be coupled to the second bus 214 including, for example, a keyboard and/or mouse 218, communication devices 220 and a storage unit 222 such as a disk drive or other mass storage device which may include instructions/code and data 224, in an embodiment. Further, an audio I/O 226 may be coupled to the second bus 214. Note that other architectures may be deployed for the multiprocessor system 170. For example, instead of the point-to-point architecture of FIG. 6, the multiprocessor system 170 may implement a multi-drop bus or other such architectures.

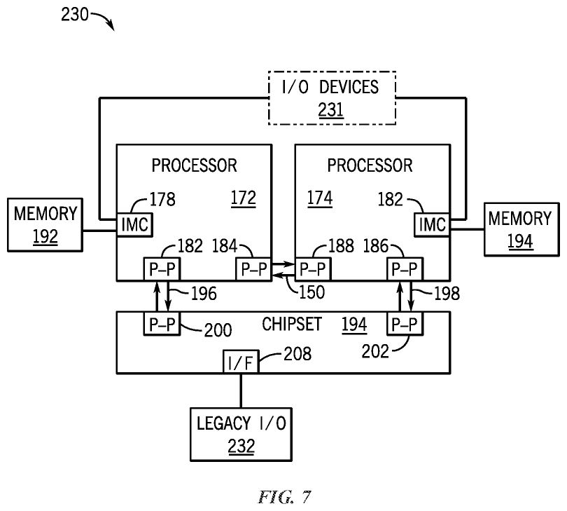

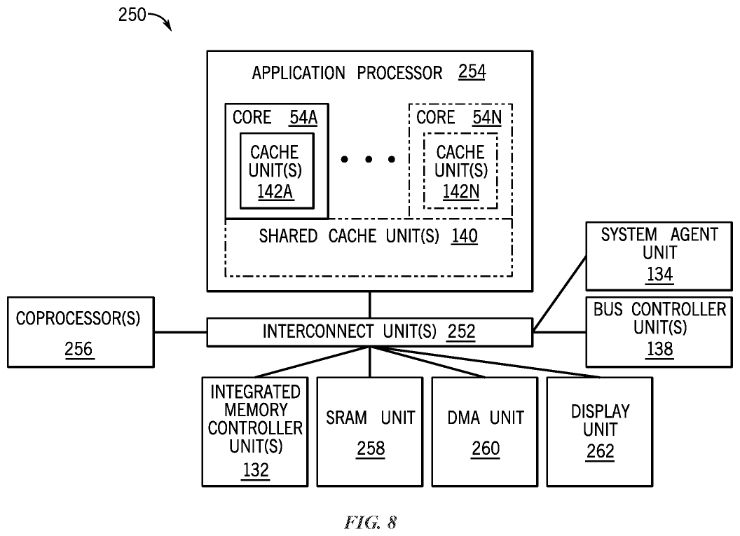

Referring now to FIG. 7, shown is a block diagram of a system 230 in accordance with an embodiment. Like elements in FIGS. 7 and 8 contain like reference numerals, and certain aspects of FIG. 6 have been omitted from FIG. 7 to avoid obscuring other aspects of FIG. 7.

FIG. 7 illustrates that the processors 172, 174 may include integrated memory and I/O control logic (“IMC”) 178 and 180, respectively. Thus, the IMC 178, 180 include integrated memory controller units and include I/O control logic. FIG. 7 illustrates that not only are the memories 192, 193 coupled to the IMC 178, 180, but also that I/O devices 231 are also coupled to the IMC 178, 180. Legacy I/O devices 232 are coupled to the chipset 194 via interface 208.

Referring now to FIG. 8, shown is a block diagram of a SoC 250 in accordance with an embodiment. Similar elements in FIG. 4 have like reference numerals. Also, dashed lined boxes are optional features included in some SoCs 250. In FIG. 8, an interconnect unit(s) 252 is coupled to: an application processor 254 that includes a set of one or more cores 54A-N that includes cache units 142A-N, and shared cache unit(s) 140; a system agent unit 134; a bus controller unit(s) 138; an integrated memory controller unit(s) 132; a set or one or more coprocessors 256 that may include integrated graphics logic, an image processor, an audio processor, and/or a video processor; a static random access memory (SRAM) unit 258; a direct memory access (DMA) unit 260; and a display unit 262 to couple to one or more external displays. In an embodiment, the coprocessor(s) 256 include a special-purpose processor, such as, for example, a network or communication processor, a compression engine, a GPGPU, a high-throughput MIC processor, an embedded processor, or the like.

Embodiments of the mechanisms disclosed herein may be implemented in hardware, software, firmware, or a combination of such implementation approaches. Embodiments of the disclosure may be implemented as computer programs and/or program code executing on programmable systems including at least one processor, a storage system (including volatile and non-volatile memory and/or storage elements), at least one input device, and at least one output device.

Program code, such as data 224 illustrated in FIG. 6, may be applied to input instructions to perform the functions described herein and generate output information. The output information may be applied to one or more output devices. For purposes of this application, a processing system includes any system that has a processor, such as, for example, a digital signal processor (DSP), a microcontroller, an application-specific integrated circuit (ASIC), or a microprocessor.

The program code may be implemented in a high-level procedural or object-oriented programming language to communicate with a processing system. The program code may also be implemented in an assembly language or in a machine language. In fact, the mechanisms described herein are not limited in scope to any particular programming language. In any case, the language may be a compiled language or an interpreted language.

One or more aspects of at least one embodiment may be implemented by representative instructions stored on a machine-readable medium that represents various logic within the processor that, when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic cards, optical cards, or any other type of media suitable for storing electronic instructions.

Accordingly, embodiments of the embodiment include non-transitory, tangible machine-readable media containing instructions or containing design data, such as designs in Hardware Description Language (HDL) that may define structures, circuits, apparatuses, processors and/or system features described herein. Such embodiments may also be referred to as program products.

### Emulation

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert instructions to one or more other instructions to be processed by the core. The instruction converter may be implemented in software, hardware, firmware, or a combination thereof. The instruction converter may be implemented on processor, off processor, or part on and part off processor.

FIG. 9 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or any combinations thereof. FIG. 9 shows a program in a high-level language 280 may be compiled using an x86 compiler 282 to generate x86 binary code 284 that may be natively executed by a processor with at least one x86 instruction set core 286. The processor with at least one x86 instruction set core 286 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 282 represents a compiler that is operable to generate x86 binary code 284 (e.g., object code) that can, with or without additional linkage processing, be executed on the processor with at least one x86 instruction set core 286.

Similarly, FIG. 9 shows the program in the high-level language 280 may be compiled using an alternative instruction set compiler 288 to generate alternative instruction set binary code 290 that may be natively executed by a processor without at least one x86 instruction set core 292 (e.g., a processor with processor cores 54 that execute the MIPS instruction set of MIPS Technologies of Sunnyvale, Calif. and/or that execute the ARM instruction set of ARM Holdings of Sunnyvale, Calif.). An instruction converter 294 is used to convert the x86 binary code 284 into code that may be natively executed by the processor without an x86 instruction set core 292. This converted code is not likely to be the same as the alternative instruction set binary code 290 because an instruction converter capable of this is difficult to make; however, the converted code may accomplish the general operation and be made up of instructions from the alternative instruction set. Thus, the instruction converter 294 represents software, firmware, hardware, or a combination thereof that, through emulation, simulation or any other process, allows a processor or other electronic device that does not have an x86 instruction set processor or core to execute the x86 binary code 284.

### Software-Driven IOMMU Prioritization in a Virtualized Datacenter

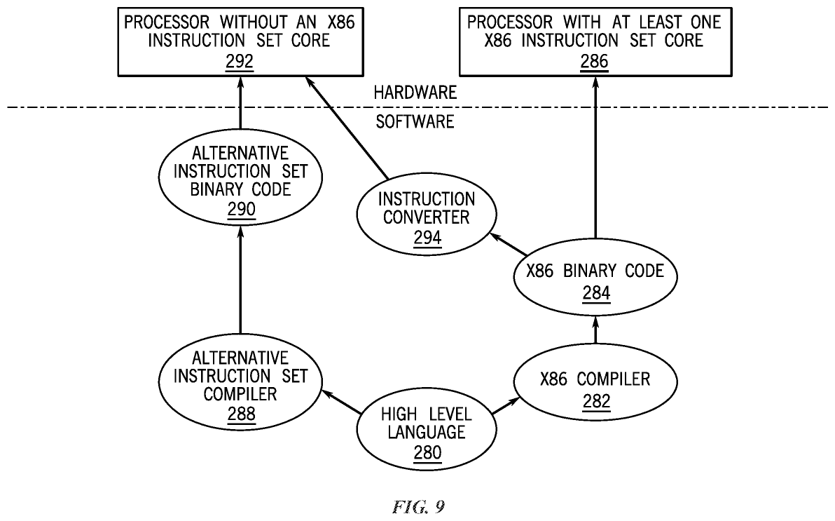

Software running on a processing device such as discussed above with reference to FIGS. 1-9 may be used to create a virtualized datacenter, which may provide web hosting, streaming services, remote computing, and more. As mentioned above, virtualization allows the creation of multiple simulated environments, operating systems (OS), or dedicated resources from a single, physical hardware system. FIG. 10 illustrates one example use case of a virtualized datacenter 300, in which a processing device 302 runs multiple virtual machines (VM) 304A and 304B. Additional VMs 304 may be brought online or dismissed in response to changing demands for computing resources. The VMs 304 shown in the virtualized datacenter 300 of FIG. 10 may interface with a client device outside of the virtualized datacenter 300 or may interface with other types of clients, including other VMs 304 or applications. The VMs 304A and 304B may have respective guest memory 306A and 306B resources that may be accessed by a peripheral device 308 using a form of Direct Memory Access (DMA) through Address Translation Service (ATS).

The VMs 304 may interact with any suitable number and types of peripheral devices 308. In one example, the peripheral device 308 may be a smart network interface card (NIC) that allows a client device to communicate with the VM 304. Other example peripheral devices 308 may include any suitable Peripheral Component Interconnect express (PCIe) devices. Examples of peripheral devices 308 that may be accessed by the VMs 304 include a network interface card (NIC), a storage device such as non-volatile memory (e.g., an NVM Express device), a cryptographic engine (e.g., Look-Aside Crypto), a compression engine, or a remote direct memory access (RDMA) device, among others.

The VMs 304A and 304B may share access to the peripheral device 308 using a form of Direct Memory Access (DMA) through Address Translation Service (ATS). An IOMMU 310 of the processing device 302 may provide hardware resources to enable the VMs 304 or applications (e.g., applications running on a native operating system or running on a VM 304). For example, the IOMMU 310 may cache translations of virtual memory addresses to physical memory addresses to reduce latency. The IOMMU 310 may also be referred to as a system memory management unit (SMMU).

In the example of FIG. 10, the IOMMU 310 may generally exercise a quality-of-service (QoS) policy that provides equal access to different VMs 304. At times, however, certain VMs 304 may run workloads that are more critical than those running on other VMs 304. In an example shown in FIG. 11, the VM 304B is shown to be running a critical workload. Under such conditions, the processing device 302 may specify the VM 304B to have priority over other VMs 304 or applications (e.g., via a user command or a determination by software managing the virtual machine (VMs) 304). In response, the input/output memory management unit (IOMMU) 310 may carry out a quality-of-service (QoS) policy that prioritizes the VM 304B. For example, the input/output memory management unit (IOMMU) 310 may reserve certain hardware resources for the VM 304B to give the VM 304B greater access to the peripheral device 308.

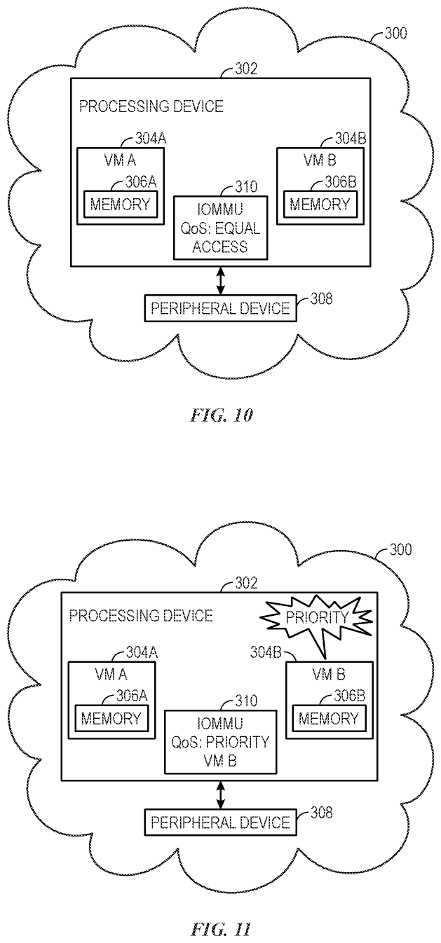

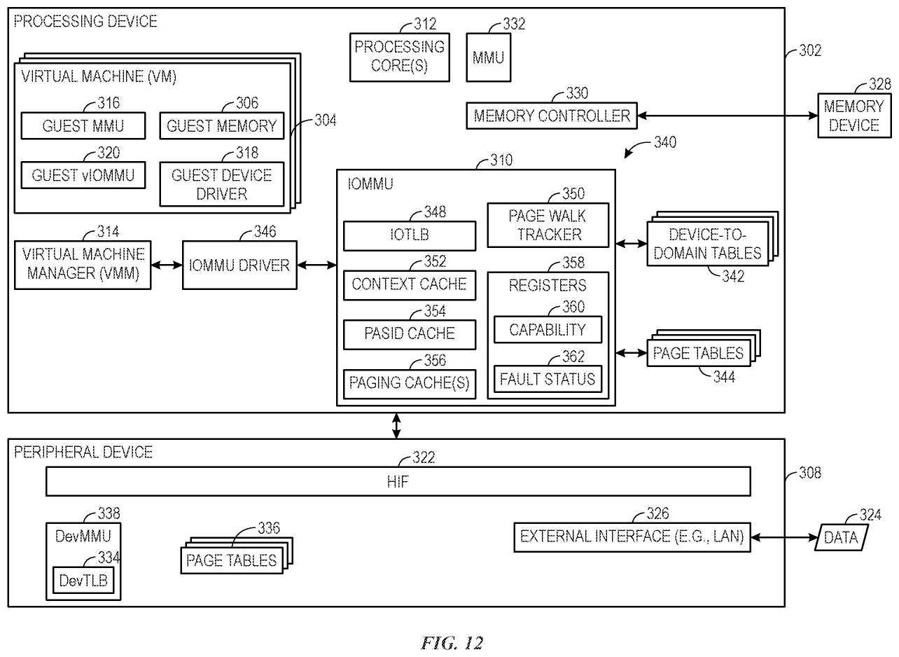

FIG. 12 is a block diagram of a processing device 302 in communication with a peripheral device 308. The processing device 302 may use software to adjust the operation of the QoS policy of the input/output memory management unit (IOMMU) 310, allowing an application or VM 304 to gain greater access to the peripheral device 308 when running a critical workload. The processing device 302 may represent any suitable processor or CPU. As used in this disclosure, the terms “processor” and “CPU” refer to a device that can execute instructions encoding arithmetic, logical, or I/O operations to carry out the systems and methods of this disclosure. For example, the processing device 302 may include an arithmetic logic unit (ALU), a control unit, and registers, and may operate in the manner discussed above with reference to FIGS. 1-9. The processing device 302 includes processing core(s) 312 that may run software such as an operating system (OS) upon which other software components may run. These other software components will be discussed further below. They include the VM 304, a virtual machine manager (VMM) 314, as well as a variety of drivers to enable the VM 304 to interact with devices and applications such as the peripheral device 308.

The processing device 302 may have any suitable number of processing cores 312. The processing device 302 may be a single-core processor having one processing core 312 that processes a single instruction pipeline or a multi-core processor having multiple processing cores 312 that may simultaneously process multiple instruction pipelines. The processing device 302 may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, and similar processors. In some cases, the processing device 302 may be implemented as a single integrated circuit, two or more integrated circuits, or may be a component of a multi-chip module (e.g., in which individual microprocessor dies are included in a single integrated circuit package and hence share a single socket). The processing device 302 may be part of a computing system such as a datacenter server, a desktop computer, a tablet computer, a laptop computer, a netbook, a notebook computer, a personal digital assistant (PDA), a workstation, a cellular telephone, a mobile computing device, an Internet appliance or any other type of computing device. In some cases, the processing device 302 may be used in a system-on-a-chip (SoC) system or system-in-package (SiP) system.

In one example, the processing device 302 is a disaggregated server. A disaggregated server is a server that breaks up components and resources into subsystems and connects them through network connections (e.g., network sleds). Disaggregated servers can be adapted to changing storage or compute loads as needed without replacing or disrupting an entire server for an extended period of time. A server could, for example, be broken into modular compute, I/O, power, and storage modules that can be shared among other nearby servers. The processing device 302 may include any other suitable components to support the operation of the VM 304, such as a communication bus between components of the processing device 302, a graphics controller, local cache memory (e.g., L4, L3, L2, L1 cache), and other supporting circuitry and software.

Virtualization is implemented using software, such as the virtual machine manager (VMM) 314, which may monitor and manage the VM 304. The virtual machine manager (VMM) 314 may represent a hypervisor such as such as Kernel-based Virtual Machine (KVM), Xen, ESXi software by VMware, or the like. The virtual machine manager (VMM) 314 may abstract a physical layer of the processing device 302, presenting this abstraction to the VMs 304 (sometimes referred to as the “guests”). The virtual machine manager (VMM) 314 may provide a virtual operating platform for the VMs 304. The VMs 304 may also be referred to as domains. In some cases, the virtual machine (VMs) 304 may represent secure trusted domains (e.g., a trust domain (TD)). When a VM 304 represents a trust domain (TD), any suitable trusted virtual machine security schemes may be used, such as Intel® Trust Domain Extensions (TDX) by Intel Corporation. These security features may isolate trust domains (TD) from each other, other VMs 304, the virtual-machine manager (VMM) 314, and any other non-TD software on the platform to protect TDs from a broad range of software. In some implementations, more than one virtual machine manager (VMM) 314 may support different VMs 304. Each VM 304 may be a software implementation of a machine that executes programs as though it were an actual physical machine. For example, the VM 304 illustrated in FIG. 12 may include a guest memory management unit (MMU) 316 that may manage guest memory 306. A guest device driver 318 may allow the VM 304 to interface with the peripheral device 308. A virtual input/output memory management unit (vIOMMU) 320 may act as a virtual model of a guest input/output memory management unit (IOMMU) that facilitates access to resources of the system input/output memory management unit (IOMMU) 310.

The VMs 304 may interact with the peripheral device 308 as if they were physical machines using a form of direct memory access (DMA) for a virtual function (VF) or physical function (PF) of the peripheral device 308. The peripheral device 308 may interface with the guest device drivers 318 through a host interface (HIF) 322. The peripheral device 308 may directly access hardware components of the processing device 302, such as to read from or write to the physical memory corresponding to the guest memory 306 of the VM 304. For a VM 304 that acts as a trust domain (TD), the peripheral device 308 may interface with that VM 304 through a trusted intermediary (e.g., a TDX Module by Intel Corporation, a TDXio (a trusted execution environment (TEE) Security Manager) module).

One way a VM 304 may interface with the peripheral device 308 is by sending or receiving data over network interface. For example, the peripheral device 308 may receive incoming data 324 into an external interface 326 that may be destined for the VM 304. In some cases, the peripheral device 308 may be a network interface card (NIC) that receives networking data into a local area network (LAN) interface. The peripheral device 308 may transfer the data 324 into the guest memory 306 of the VM 304 for which the data 324 is intended using direct memory access (DMA).

Before continuing, it should be understood that, while data is physically stored at a physical memory address representing an actual location in physical memory (e.g., an actual physical location on a memory device 328 that may be accessed through a memory controller 330, managed by a memory management unit (MMU) 332), software running on the processing device 302 and the peripheral device 308 may operate using a virtual memory address that is translated to the physical memory address when the memory is accessed. A structure known as a translation lookaside buffer (TLB) stores recently used mappings of virtual memory addresses to their corresponding physical memory addresses. There may be multiple TLBs used by the processing device 302 and peripheral device 308 for memory for specific domains. The peripheral device 308 may maintain a local cache of recently accessed mappings between virtual memory addresses and physical memory addresses for I/O access in the form of a device translation lookaside buffer (devTLB) 334 and associated page tables 336. The device translation lookaside buffer (devTLB) 334 and associated page tables 336 may be used and maintained by a device memory management unit (devMMU) 338.

To transfer the data 324 to the guest memory 306 of the VM 304, the device translation lookaside buffer (devTLB) 334 may rapidly translate the virtual memory address to its corresponding physical memory address. The peripheral device 308 may use DMA to store the data 324 in the physical memory of the processing device 302 corresponding to the guest memory 306 of the receiving VM 304.

If the device translation lookaside buffer (devTLB) 334 does not currently have an entry corresponding to the request, however, this may be referred to as a “cache miss” or “TLB miss.” A TLB miss handling process is used to obtain the corresponding entry by conducting a search known as a “page walk” through the page tables 336. If the page walk does not identify the physical memory address that corresponds to the requested virtual memory address, the peripheral device 308 may request the translation from the processing device 302. For example, the peripheral device 308 may send an Address Translation Service (ATS) message requesting the translation.

In the processing device 302, I/O memory management blocks 340, such as the IOMMU 310, device-to-domain tables 342, and page tables 344, may track remapping translations between virtual memory addresses and physical memory addresses. The device-to-domain tables 342 may include any suitable tables that map a peripheral device 308, or a physical function (PF) or virtual function (VF) of a peripheral device 308, to respective domains (e.g., VMs 304). These may include a root table (e.g., relating to domain identifiers) or a process address space identifier (PASID) table (e.g., relating to a particular process running in a particular domain). The page tables 344 store remapping translations of virtual memory addresses to physical memory addresses. The peripheral device 308 or the virtual machine monitor (VMM) 314 may communicate with the input/output memory management unit (IOMMU) 310 using an input/output memory management unit (IOMMU) driver 346. In one example, the input/output memory management unit (IOMMU) driver 346 may represent an I/O driver such as a virtualization technology-direct (VT-d) driver that allows authorized technology direct I/O access. In another example, the input/output memory management unit (IOMMU) driver 346 may represent software in a layer of an operating system residing on top of an I/O driver such as a virtualization technology-direct (VT-d) driver. input/output memory management unit (IOMMU) Among other circuitry, the input/output memory management unit (IOMMU) 310 includes an input/output translation lookaside buffer (IOTLB) 348 that caches recently stored translations between physical memory addresses and virtual memory addresses. If the requested translation is in the input/output translation lookaside buffer (IOTLB) 348, the physical memory address may be provided in response and the peripheral device 308 may use DMA to store the data 324 in the proper physical address on the processing device 302, making it accessible to the VM 304 by way of its guest memory 306. If the input/output translation lookaside buffer (IOTLB) 348 does not currently have an entry corresponding to the request, however, a TLB miss handling process is used to obtain the corresponding entry by conducting a page walk through the page tables 344 using a page walk tracker 350. If the page walk is successful, a response may provide the translation to the peripheral device 308, which may store the translation as an entry in the device translation lookaside buffer (devTLB) 334.

In addition to the input/output translation lookaside buffer (IOTLB) 348, the input/output memory management unit (IOMMU) 310 may also hold other caches, such as a context cache 352, a process address space identifier (PASID) cache 354, and any suitable number of paging cache(s) 356. The context cache 352 may cache a context-entry or scalable-mode context-entry encountered on an address translation of a request. Each cached entry of the context cache 352 may be referenced by a source-id in the request. If the context cache 352 does not hold a corresponding entry for a request, the context cache 352 may retrieve an entry from a root table entry of the device-to-domain tables 342. The process address space identifier (PASID) cache 354 may cache scalable-mode process address space identifier (PASID) table entries encountered on address translation of a request. If the context cache 352 does not hold a corresponding entry for a request, the process address space identifier (PASID) cache 354 may retrieve an entry from a process address space identifier (PASID) table entry of the device-to-domain tables 342. The entries of the context cache 352 and/or the process address space identifier (PASID) cache 354 may be used to access paging structure entries of the paging cache(s) 356. The input/output memory management unit (IOMMU) 310 may have more or fewer caches than those described here.

The input/output memory management unit (IOMMU) 310 may also include a number of registers 358, such as capability register(s) 360 and fault status register(s) 362. The input/output memory management unit (IOMMU) 310 may be designed to carry out any suitable quality-of-service (QoS) policy with respect to different VMs 304 or with respect to different applications running on the virtual machines (VMs) or operating system. The capability register(s) 360 may indicate various capabilities of the input/output memory management unit (IOMMU) 310, including whether the input/output memory management unit (IOMMU) 310 supports reserving hardware resources of the input/output memory management unit (IOMMU) 310 such as the input/output translation lookaside buffer (IOTLB) 348, context cache 352, process address space identifier (PASID) cache 354, or paging cache(s) 356. The fault status register(s) 362 may provide an indication of a fault that software can use for error handling.

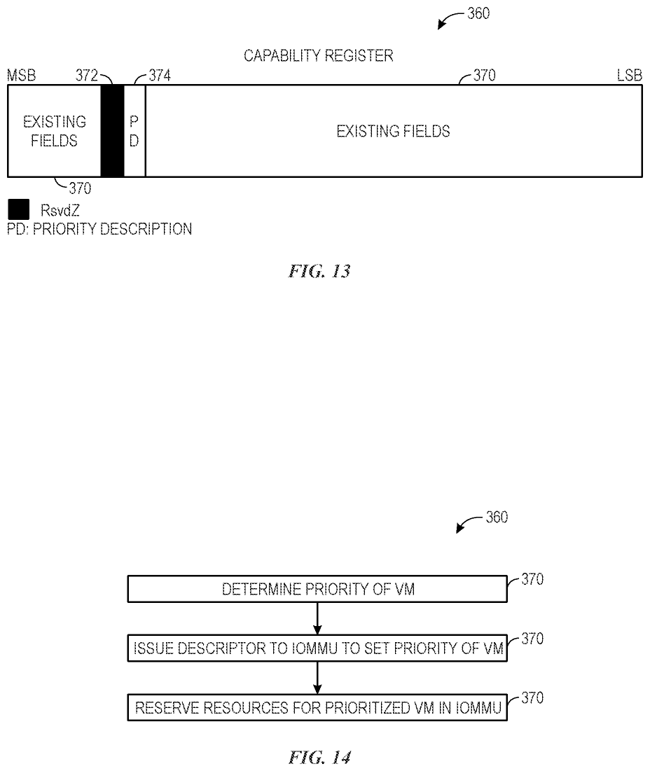

FIG. 13 provides a schematic diagram of the capability register 360. The capability register 360 may include several bits from least significant bit (LSB) on the right to most significant bit (MSB) on the left. The capability register 360 includes a number of bits in existing fields 370 and a number of reserved bits 372. A priority descriptor (PD) field 374 occupies one or more bits of the capability register 360. The priority descriptor (PD) field 374 may represent a single bit or multiple bits to indicate the prioritization capabilities of the input/output memory management unit (IOMMU) 310. In some examples, the priority descriptor (PD) field 374 may include a single bit that indicates whether the input/output memory management unit (IOMMU) 310 has the capability to prioritize one VM 304 or a process address space identifier (PASID) of a virtual machine (VM) or another application over others, or the like. In another example, the priority descriptor (PD) field 374 may include multiple bits and may indicate whether multiple possible prioritization levels are supported. Software such as the virtual machine manager (VMM) 314 may read the capability register 360 to determine the extent to which the input/output memory management unit (IOMMU) 310 may be issued a priority descriptor to prioritize a VM 304, an application (PASID) of a VM 304, or another application running on an operating system of the processing device 302 over others. For example, if the capability is supported, the virtual machine manager (VMM) 314 may prioritize a VM 304 that is running a critical workload. In a non-virtualized environment, a bare metal operating system (OS) can issue a priority descriptor to increase the priority of a running process or container. The OS may detect that the critical process is waiting on input/output memory management unit (IOMMU) 310 hardware resources and prioritize the process/container using the systems and methods of this disclosure.

One example of prioritizing a VM 304, process address space identifier (PASID) of a VM 304, or process address space identifier (PASID) of an application is shown in a flowchart 380 of FIG. 14. Software such as the virtual machine manager (VMM) 314, a bare metal operating system (OS), or other higher-level software may determine that a selected VM 304, application (e.g., process address space identifier (PASID)) of a VM 304, or process address space identifier (PASID) of a non-virtualized application should be prioritized (block 382). This may be particularly useful for a critical workload for which access to a peripheral device 308 with lower latency and/or higher throughput is desirable. In one particular example, a critical workload may be running on a VM 304 when the VM 304 is being migrated from one processing device 302 to another processing device 302 (e.g., undergoing live migration), and is using the peripheral device 308 to send data to or receive data from the other processing device 302. However, any suitable workload deemed critical may justify prioritization. Moreover, the decision to prioritize one VM 304, process address space identifier (PASID) of a VM 304, or process address space identifier (PASID) of an application may be set by an operator (e.g., via a graphical user interface or command line interface) or may be determined by software. For example, the virtual machine manager (VMM) 314 may identify that a particular VM 304 is running a critical workload (e.g., being migrated) and may determine to prioritize that VM 304 to ensure high quality of service (QoS) in the input/output memory management unit (IOMMU) 310. A VM 304 may also include registers or a file that indicate certain conditions under which it is to be prioritized to the virtual machine manager (VMM) 314. For example, such registers or a file may indicate that certain operations that may be carried out by the VM 304 are to be considered critical workloads that justify higher-priority access to the input/output memory management unit (IOMMU) 310 resources.

Having determined to prioritize a particular VM 304, process address space identifier (PASID) of the VM 304, or process address space identifier (PASID) of the application, the virtual machine manager (VMM) 314 may issue a priority descriptor to the input/output memory management unit (IOMMU) 310 (block 384). As discussed below, the priority descriptor may specify the domain (e.g., VM 304) and/or the process address space identifier (PASID) that should receive priority access to the input/output memory management unit (IOMMU) 310 resources. In some cases, as will be discussed further below, the priority descriptor may also indicate a particular level of priority. In response, the input/output memory management unit (IOMMU) 310 may reserve resources of the input/output memory management unit (IOMMU) 310 for the selected VM 304, process address space identifier (PASID) of the VM 304, or process address space identifier (PASID) of the application (block 386).

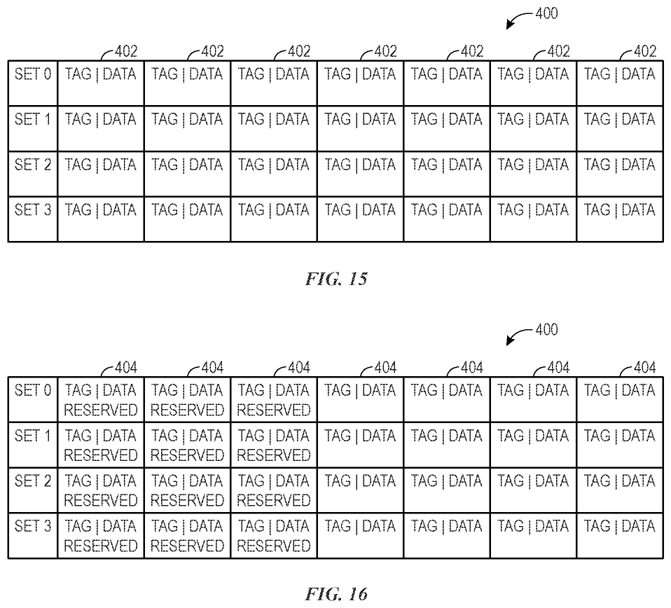

The input/output memory management unit (IOMMU) 310 may include a variety of resources that may be reserved to implement a quality of service (QoS) policy that prioritizes a selected VM 304, process address space identifier (PASID) of the VM 304, or process address space identifier (PASID) of the application. FIGS. 15 and 16 illustrate an example in which cache of the input/output memory management unit (IOMMU) 310 (e.g., the input/output translation lookaside buffer (IOTLB) 348, the context cache 352, the process address space identifier (PASID) cache 354, or the paging cache(s) 356) may be reserved. In the particular example of FIGS. 15 and 16, a 4-set, 8-way set-associative cache implementation 400 is shown. The input/output memory management unit (IOMMU) 310 is not prioritizing a selected VM 304, process address space identifier (PASID) of the VM 304, or application in FIG. 15. As such, cache entry locations 402, which may hold a cache tag and data, may be used by any VM 304 or process address space identifier (PASID). The input/output memory management unit (IOMMU) 310 may not prioritize placement of one VM 304 or process address space identifier (PASID) over another. Data may reside on any of the available cache entry locations 402, as per the cache specification.

By contrast, FIG. 16 shows the cache implementation 400 after the virtual machine manager (VMM) 314 has issued a priority descriptor that prioritizes a selected VM 304 or process address space identifier (PASID). Here, 50% of the available cache entry locations 402 have been designated as reserved cache entry locations 404 for the selected VM 304 or process address space identifier (PASID). In other examples, different levels of reservation may be used. The example of 50% is provided by way of example and is not meant to be exhaustive. Indeed, depending on the design of the input/output memory management unit (IOMMU) 310 and/or a specified level of priority desired, the fraction of reserved cache entry locations 404 may be lower or higher (e.g., 10%, 25%, 75%, 90%) and other resources of the input/output memory management unit (IOMMU) 310 may be reserved other than the cache resources (e.g., management hardware of the input/output memory management unit (IOMMU) 310, the page walk tracker 350). In the example of FIG. 16, the input/output memory management unit (IOMMU) 310 may include may first evict data from the reserved cache entry locations 404 that it identifies as reserved for the selected VM 304 or process address space identifier (PASID). This is then followed by reserving the space for the highest priority VM 304 or process address space identifier (PASID) and not utilizing it for other virtual machine (VMs) or process address space identifier (PASID)s. Once the selected VM 304 or process address space identifier (PASID) or is no longer prioritized, the QoS policy of the input/output memory management unit (IOMMU) 310 may return to its previous state, as illustrated in FIG. 15, in which the input/output memory management unit (IOMMU) 310 may not prioritize placement of data based on VM 304 or process address space identifier (PASID).

### Start Priority and Stop Priority Descriptors to Set IOMMU Priority

The priority descriptor sent from the virtual machine manager (VMM) 314 to the input/output memory management unit (IOMMU) 310 may take a variety of forms. In one example, described in a flowchart 420 of FIG. 17, the virtual machine manager (VMM) 314 may use different priority descriptors to start and stop prioritization of a VM 304 or process address space identifier (PASID). The virtual machine manager (VMM) 314 may determine that a selected VM 304, process address space identifier (PASID) of a VM 304, or process address space identifier (PASID) of an application should be prioritized (block 422). Having determined to prioritize a particular VM 304, process address space identifier (PASID) of the VM 304, or process address space identifier (PASID) of the application, the virtual machine manager (VMM) 314 may issue a start priority descriptor to the input/output memory management unit (IOMMU) 310 (block 424). In response, the input/output memory management unit (IOMMU) 310 may reserve resources of the input/output memory management unit (IOMMU) 310 for the selected VM 304, process address space identifier (PASID) of the VM 304, or process address space identifier (PASID) of the application (block 426). When the VM 304, process address space identifier (PASID) of the VM 304, or process address space identifier (PASID) of the application is no longer to be prioritized (e.g., the critical workload has ended), the virtual machine manager (VMM) 314 may issue a stop priority descriptor to the input/output memory management unit (IOMMU) 310 (block 428). The input/output memory management unit (IOMMU) 310 may subsequently return to a previous (e.g., a default) quality of service (QoS) policy that does not reserve resources of the input/output memory management unit (IOMMU) 310 for the selected VM 304, process address space identifier (PASID) of the VM 304, or process address space identifier (PASID) of the application (block 430).

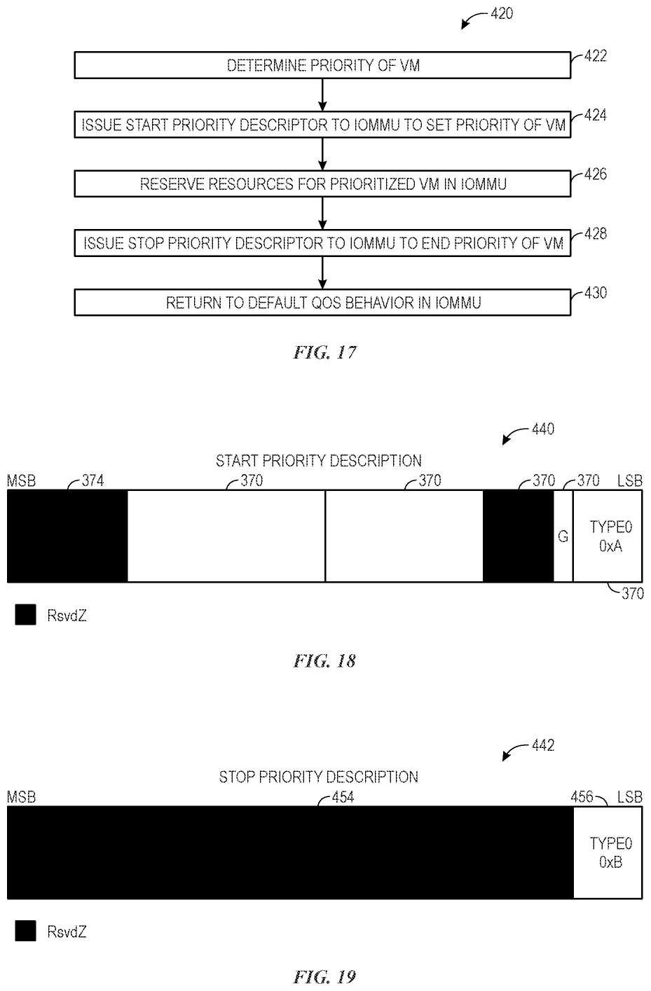

FIG. 18 provides an example of a start priority descriptor 440 and FIG. 19 provides an example of a stop priority descriptor 442. Both may include any suitable number of bits, shown here from least significant bit (LSB) on the right to most significant bit (MSB) on the left. It should be appreciated that the positioning and relative sizes of the parameters of the start priority descriptor 440 and the stop priority descriptor 442 are provided by example and are meant to represent the kind of parameters that may be found in the start priority descriptor 440 and stop priority descriptor 442. There may be more or fewer parameters, and the parameters may take other relative positions and/or sizes.

The start priority descriptor 440 of FIG. 18 includes a number of reserved bits 444, around which other parameters are positioned. A type field 446 includes any suitable code that may be interpreted by the input/output memory management unit (IOMMU) 310 as indicating the start of a prioritization of resources. A granularity (G) field 448 may indicate the requested granularity that the cache tags are to be matched. For example, the encoding of the granularity (G) field 448 may be (00b) domain-selective: cache tags are to match the specified domain-id field; (01b) process address space identifier (PASID)-Selective-within-Domain: cache tags are to match the specified domain-id and specified process address space identifier (PASID) value; and (10b and 11b) reserved: descriptor with a reserved value may be interpreted as invalid. A domain identifier (DID) field 450 may indicate the target domain-ID (e.g., a particular VM 304 that has been selected to prioritize). A process address space identifier (PASID) field 452 may indicate the target process address space within the domain (e.g., a particular process address space identifier (PASID) of the VM 304 that has been selected to prioritize).

The stop priority descriptor 442 of FIG. 19 includes a number of reserved bits 454 and a type field 456. The type field 456 includes any suitable code that may be interpreted by the input/output memory management unit (IOMMU) 310 as indicating the end of prioritization of resources.

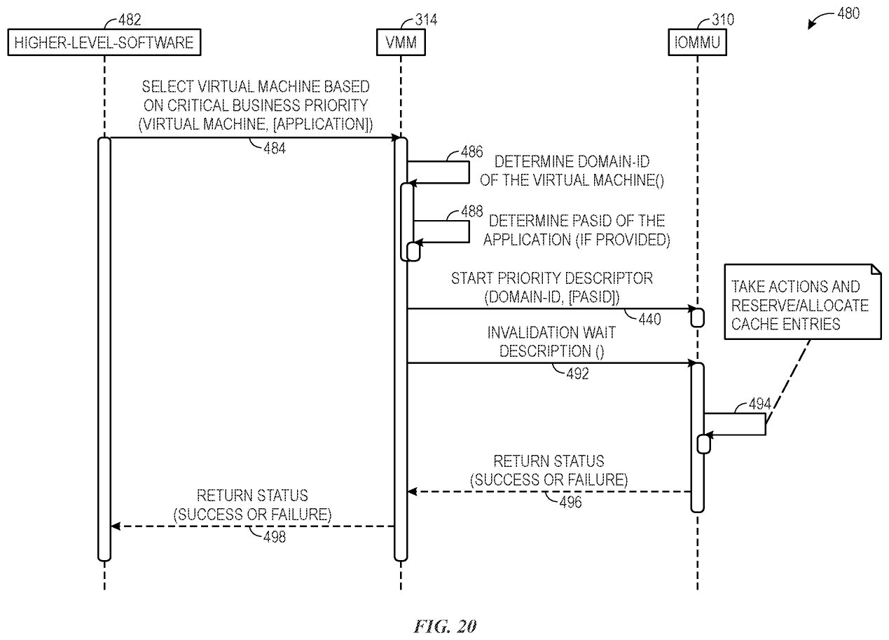

A flow diagram 480 of FIG. 20 illustrates various actions that may be taken when a start priority descriptor 440 is provided to the input/output memory management unit (IOMMU) 310. Higher-level software 482 (e.g., control software that provides an operator control over the virtual machine (VMs) 304) may indicate (signal 484) that a particular VM 304 and/or a specific application running on the VM 304 has been selected based on a critical business priority. As mentioned above, the selection may come from a human operator (e.g., via a graphical user interface or command line interface) or may be determined by software. In some cases, the prioritization may be determined by the virtual machine manager (VMM) 314. In response to the signal 484 indicating the selected VM 304 and/or application running on the VM 304, the virtual machine manager (VMM) 314 may determine a domain-ID of the selected VM 304 and store (signal 486) the value of the domain ID in the domain identifier (DID) field 450 of a start priority descriptor 440. If an application running on the VM 304 was also specified, the virtual machine manager (VMM) 314 may further determine the process address space identifier (PASID) of the application and store (signal 488) the value of the process address space identifier (PASID) in the process address space identifier (PASID) field 452 of the start priority descriptor 440. The virtual machine manager (VMM) 314 may issue the start priority descriptor 440 to the input/output memory management unit (IOMMU) 310. The input/output memory management unit (IOMMU) 310 may hold the start priority descriptor 440 until receiving an invalidation wait descriptor (signal 492) from the virtual machine manager (VMM) 314. This allows the software to synchronize with hardware for the start priority descriptor 440 submitted before the wait descriptor. At any time, there is no more than one ‘Start Priority Descriptor’ pending or executing in the input/output memory management unit (IOMMU) 310. Failure to follow the guidance may result in error being reported by the input/output memory management unit (IOMMU) 310 via the fault status registers 362.

When the input/output memory management unit (IOMMU) 310 receives the start priority descriptor 440 and the invalidation wait descriptor, the input/output memory management unit (IOMMU) 310 may perform several actions (actions 494). These may include (1) handling error conditions if there is already a pending start priority descriptor 440, (2) using the Domain-ID and/or process address space identifier (PASID) in the submitted descriptor as tags, (3) lengthening residency of the cache entries in the caches of the input/output memory management unit (IOMMU) 310 by matching the tags submitted in the start priority descriptor 440, (4) dynamically reserving cache entries for new incoming DMA translations matching the tags determined above, (5) dynamically evicting cache entries to allocate space for the new prioritized entries, and/or (6) continuing to perform these actions until a ‘Stop Priority Descriptor’ is submitted. The input/output memory management unit (IOMMU) 310 may also issue a return status (signal 496) to the virtual machine manager (VMM) 314 indicating success or failure, which may be passed on (signal 498) by virtual machine manager (VMM) 314 to the higher-level software 482.

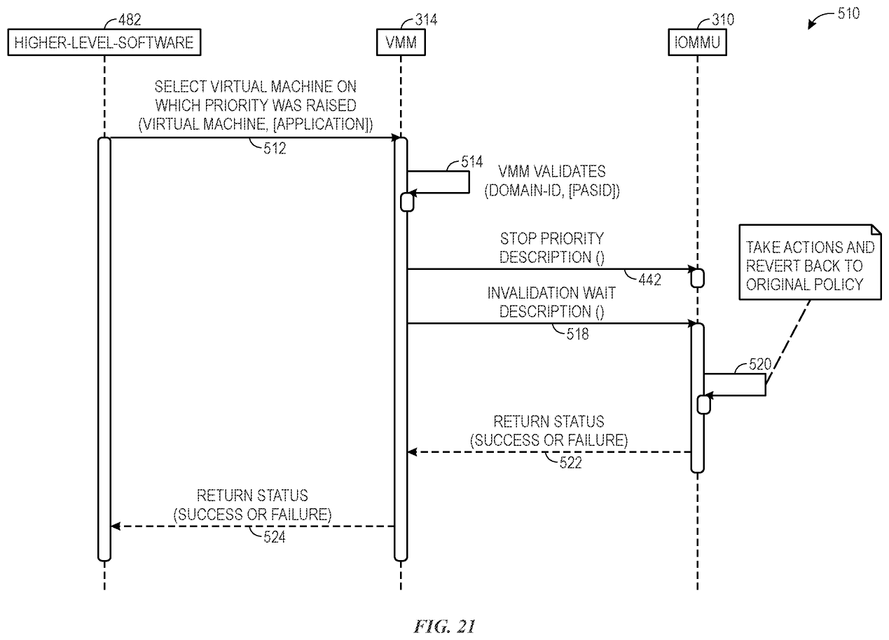

A flow diagram 510 of FIG. 21 illustrates various actions that may be taken when a stop priority descriptor 442 is provided to the input/output memory management unit (IOMMU) 310. Higher-level software 482 (e.g., control software that provides an operator control over the virtual machine (VMs) 304) may indicate (signal 512) that the previously selected VM 304 and/or specific application running on the VM 304 has been selected no longer to be prioritized based on a critical business priority. In response to the signal 512, the virtual machine manager (VMM) 314 may validate (signal 514) the domain-ID of the previously selected VM 304 and/or the process address space identifier (PASID) of the application. After confirmation, the virtual machine manager (VMM) 314 may issue a stop priority descriptor 442 to the input/output memory management unit (IOMMU) 310. The input/output memory management unit (IOMMU) 310 may hold the stop priority descriptor 442 until receiving an invalidation wait descriptor (signal 518) from the virtual machine manager (VMM) 314. This allows the software to synchronize with hardware for the stop priority descriptor 442 that was submitted before the wait descriptor.

When the input/output memory management unit (IOMMU) 310 receives the stop priority descriptor 442 and the invalidation wait descriptor, the input/output memory management unit (IOMMU) 310 may perform several actions (520). These may include (1) handling error conditions, if there is no pending ‘Start Priority Descriptor’, and/or (2) reverting back to the default quality of service (QoS) policy for handling allocation/eviction of cache entries. The input/output memory management unit (IOMMU) 310 may also issue a return status (signal 522) to the virtual machine manager (VMM) 314 indicating success or failure, which may be passed on (signal 524) by virtual machine manager (VMM) 314 to the higher-level software 482.

As mentioned above with reference to FIG. 12, the input/output memory management unit (IOMMU) 310 hardware implements fault status register(s) 362 to report and log non-recoverable fault events. Non-recoverable faults can be reported to software (e.g., the virtual machine manager (VMM) 314) using a message-signaled interrupt controlled through one of the fault status register(s) 362 (e.g., a fault event control register). The errors reported by the input/output memory management unit (IOMMU) 310 on a ‘Start/Stop Priority Descriptor’ submission may be classified broadly as an invalidation queue error (IQE). The conditions resulting in an IQE error can be obtained by looking into another of the fault status register(s) 362 (e.g., invalidation queue error record register (IQERCD_REG)). There may be a field referred to as an invalidation queue error info (IQEI) in this fault status register 362 that enumerates certain details about what caused the IQE field to be set. By way of example, the IQEI field may report error information using bits that, when set, may indicate that the input/output memory management unit (IOMMU) 310 has detected a new start priority descriptor 440 when a previously submitted start priority descriptor 440 is in progress and/or that the input/output memory management unit (IOMMU) 310 has detected a new stop priority descriptor 440 when a start priority descriptor 440 is not in progress.

### Universal Priority Descriptor to Set IOMMU Priority

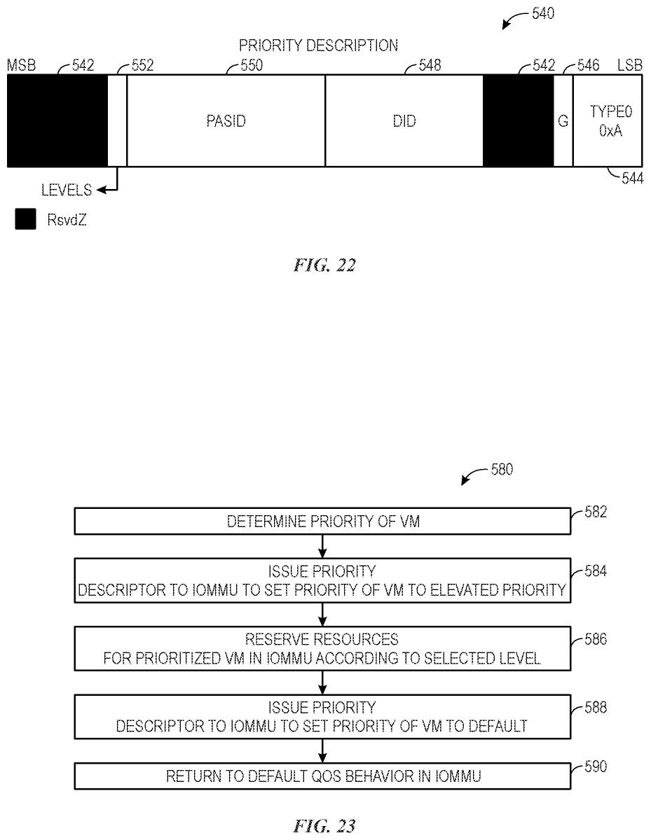

The priority descriptor sent from the virtual machine manager (VMM) 314 to the input/output memory management unit (IOMMU) 310 may also take a universal form that does not depend on separate start priority and stop priority descriptors. FIG. 22 provides an example of a priority descriptor 540 that can indicate a level of prioritization of a specified VM 304 and/or application. The priority descriptor 540 may include any suitable number of bits, shown here from least significant bit (LSB) on the right to most significant bit (MSB) on the left. It should be appreciated that the positioning and relative sizes of the parameters of the priority descriptor 540 are provided by example and are meant to represent the kind of parameters that may be found in the priority descriptor 540. There may be more or fewer parameters, and the parameters may take other relative positions and/or sizes.

The priority descriptor 540 of FIG. 22 includes a number of reserved bits 542, around which other parameters are positioned. A type field 544 includes any suitable code that may be interpreted by the input/output memory management unit (IOMMU) 310 as indicating that the descriptor is a priority descriptor. A granularity (G) field 546 may indicate the requested granularity that the cache tags are to be matched. For example, the encoding of the granularity (G) field 546 may be (00b) domain-selective: cache tags are to match the specified domain-id field; (01b) process address space identifier (PASID)-Selective-within-Domain: cache tags are to match the specified domain-id and specified process address space identifier (PASID) value; and (10b and 11b) reserved: descriptor with a reserved value may be interpreted as invalid. A domain identifier (DID) field 548 may indicate the target domain-ID (e.g., a particular VM 304 that has been selected to prioritize). A process address space identifier (PASID) field 550 may indicate the target process address space within the domain (e.g., a particular process address space identifier (PASID) of the VM 304 that has been selected to be prioritized). A levels field 552 may indicate a particular level of prioritization to apply to the specified domain-ID and/or process address space identifier (PASID).

The granularity (G) field 546, domain identifier (DID) field 548, and the process address space identifier (PASID) field 550 may operate in a similar manner to the like-named fields discussed above with reference to FIG. 18. The levels field 552 of FIG. 22 may indicate, for example, a particular priority level to apply to the selected VM 304 and/or process address space identifier (PASID). The levels field 552 may have any suitable number of discrete prioritization levels. In one example, the levels field 552 may include a single bit that can indicate whether the selected VM 304 and/or process address space identifier (PASID) has been prioritized or not. When the priority level of the levels field 552 is set to the lowest level, the input/output memory management unit (IOMMU) 310 may not apply any prioritization to the selected VM 304 and/or process address space identifier (PASID) or may stop applying a prioritization if the input/output memory management unit (IOMMU) 310 otherwise had been. In another example, the levels field 552 may include multiple bits that can indicate to which of multiple levels the selected VM 304 and/or process address space identifier (PASID) has been prioritized. For example, there may be two bits that provide the following levels of priority:
00b—Indicates lowest level of prioritization, indicating to stop a reservation policy if one were previously in place for this VM 304 and/or process address space identifier (PASID) (may operate as an equivalent to a stop priority descriptor 442)
01b—25% reservation policy
10b—50% reservation policy
11b—75% reservation policy

Using the scheme described above, the priority descriptor 540 may be submitted with an appropriate setting for the levels field 552. If the levels field 552 is set as 00b, it is interpreted by the input/output memory management unit (IOMMU) 310 as equivalent to a stop priority descriptor. If the levels field 552 is anything other than 00b, the input/output memory management unit (IOMMU) 310 may apply the encoded QoS level (e.g., 25%, 50%, 75%). The input/output memory management unit (IOMMU) 310 may be designed to carry out the specified quality of service (QoS) policy in any suitable way; in this way, the software may be agnostic to the specific QoS policy of the input/output memory management unit (IOMMU) 310 while indicating whether to increase or decrease the QoS policy of the input/output memory management unit (IOMMU) 310. This allows for changing the QoS policy using the submitted priority descriptor 540. System software may dynamically increase or decrease the input/output memory management unit (IOMMU) 310 QoS policy by submitting different priority descriptors 540 targeting the same domain-id and/or process address space identifier (PASID). The input/output memory management unit (IOMMU) 310 hardware implementation could be designed to expose the levels of prioritization as a 3-bit or greater field if finer granularity in QoS policy is desired.

Before continuing, while the priority descriptor 540 has been described as being independent from the stop priority descriptor 442, in some embodiments, priority descriptor 540 may operate as an enhanced start priority descriptor. In that case, the stop priority descriptor 442 may be used to end the prioritization of a selected VM 304 and/or process address space identifier (PASID) and the 00b bit of the levels field 552 may be a reserved bit.

A flowchart 580 of FIG. 23 represents an example of using the universal priority descriptor 540 to set a level of prioritization of the input/output memory management unit (IOMMU) 310 for a selected VM 304, process address space identifier (PASID) of the VM 304, or process address space identifier (PASID) of an application in a bare-metal setting. The virtual machine manager (VMM) 314 or other software may determine that a selected VM 304, process address space identifier (PASID) of a VM 304, or process address space identifier (PASID) of an application should be prioritized to a certain level (block 582). Having determined to prioritize the particular VM 304, process address space identifier (PASID) of the VM 304, or process address space identifier (PASID) of the application, the virtual machine manager (VMM) 314 or other software may issue a priority descriptor to the input/output memory management unit (IOMMU) 310 (block 584) that indicates a desired level of prioritization. In response, the input/output memory management unit (IOMMU) 310 may reserve resources of the input/output memory management unit (IOMMU) 310 for the selected VM 304, process address space identifier (PASID) of the VM 304, or process address space identifier (PASID) of the application in accordance with a quality of service (QoS) policy consistent with the selected level (block 586). When the VM 304, process address space identifier (PASID) of the VM 304, or process address space identifier (PASID) of the application is no longer to be prioritized (e.g., the critical workload has ended), the virtual machine manager (VMM) 314 may issue another priority descriptor to the input/output memory management unit (IOMMU) 310 setting the level of prioritization to a default level (block 588). The input/output memory management unit (IOMMU) 310 may subsequently return to a previous (e.g., a default) quality of service (QoS) policy that does not reserve resources of the input/output memory management unit (IOMMU) 310 for the selected VM 304, process address space identifier (PASID) of the VM 304, or process address space identifier (PASID) of the application (block 590).

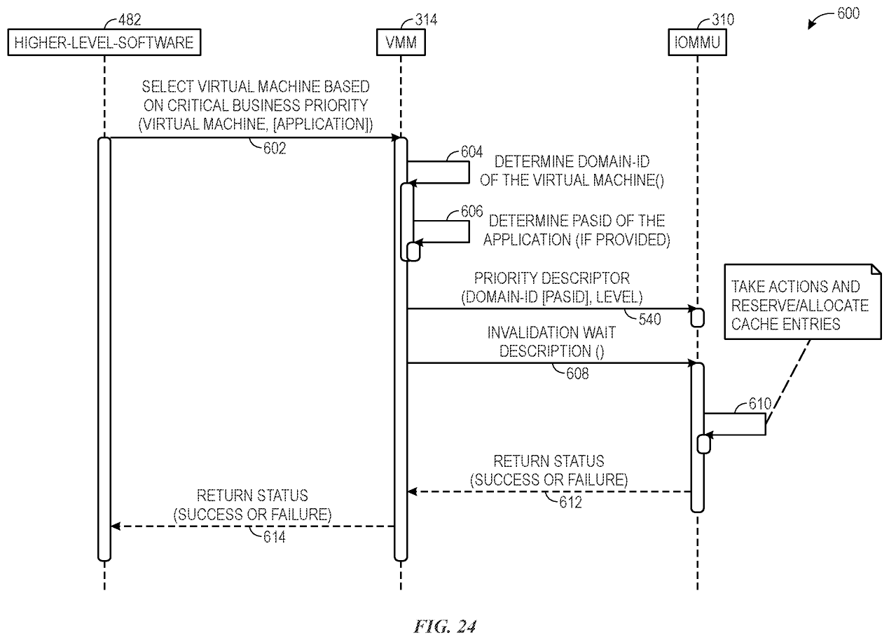

FIG. 24 illustrates a flowchart 600 showing various actions that may be taken when a priority descriptor 540 is provided to the input/output memory management unit (IOMMU) 310. Higher-level software 482 (e.g., control software that provides an operator control over the virtual machine (VMs) 304) may indicate (signal 602) that a particular VM 304 and/or a specific application running on the VM 304 has been selected based on a critical business priority and a level of desired prioritization. The selection may come from a human operator (e.g., via a graphical user interface or command line interface) or may be determined by software. In some cases, the prioritization may be determined by the virtual machine manager (VMM) 314. In response to the signal 602 indicating the selected VM 304 and/or application running on the VM 304 and the desired level of prioritization, the virtual machine manager (VMM) 314 may determine a domain-ID of the selected VM 304 and store (signal 604) the value of the domain ID in the domain identifier (DID) field 548 of a priority descriptor 540. If an application running on the VM 304 was also specified, the virtual machine manager (VMM) 314 may further determine the process address space identifier (PASID) of the application and store (signal 606) the value of the process address space identifier (PASID) in the process address space identifier (PASID) field 550 of the priority descriptor 540. The virtual machine manager (VMM) 314 may issue the priority descriptor 540 to the input/output memory management unit (IOMMU) 310. The input/output memory management unit (IOMMU) 310 may hold the priority descriptor 540 until receiving an invalidation wait descriptor (signal 608) from the virtual machine manager (VMM) 314. This allows the software to synchronize with hardware for the priority descriptor 540 submitted before the wait descriptor.

When the input/output memory management unit (IOMMU) 310 receives the priority descriptor 540 and the invalidation wait descriptor, the input/output memory management unit (IOMMU) 310 may perform several actions (actions 610). These may include (1) handling error conditions if there is already a pending priority descriptor 540 corresponding with the same VM 304 and/or process address space identifier (PASID) and same level, (2) using the Domain-ID and/or process address space identifier (PASID) in the submitted descriptor as tags, (3) lengthening residency of the cache entries in the caches of the input/output memory management unit (IOMMU) 310 by matching the tags submitted in the start priority descriptor 440 corresponding to a particular QoS policy of the input/output memory management unit (IOMMU) 310 based on the selected level, (4) dynamically reserving cache entries for new incoming DMA translations matching the tags determined above, (5) dynamically evicting cache entries to allocate space for the new prioritized entries, and/or (6) continuing to perform these actions until a new priority descriptor indicating a priority level of 0 (default) is submitted or, in some embodiments, until a ‘Stop Priority Descriptor’ is submitted. The input/output memory management unit (IOMMU) 310 may also issue a return status (signal 612) to the virtual machine manager (VMM) 314 indicating success or failure, which may be passed on (signal 614) by virtual machine manager (VMM) 314 to the higher-level software 482.

For a priority descriptor 540, the input/output memory management unit (IOMMU) 310 may employ different error handling. As mentioned above, the input/output memory management unit (IOMMU) 310 hardware implements fault status register(s) 362 to report and log non-recoverable fault events. Non-recoverable faults can be reported to software (e.g., the virtual machine manager (VMM) 314) using a message-signaled interrupt controlled through one of the fault status register(s) 362 (e.g., a fault event control register). The errors reported by the input/output memory management unit (IOMMU) 310 on a priority descriptor 540 submission may be classified broadly as an invalidation queue error (IQE). The conditions resulting in an IQE error can be obtained by looking into another of the fault status register(s) 362 (e.g., invalidation queue error record register (IQERCD_REG)). There may be a field referred to as an invalidation queue error info (IQEI) in this fault status register 362 that enumerates certain details about what caused the IQE field to be set. The IQEI field may report error information using bits that, when set, may indicate certain faults. These may include, for example, one or more bits that indicate that the input/output memory management unit (IOMMU) 310 has detected a domain-selective priority descriptor 540 with a different domain-id than a currently in-progress domain-selective priority descriptor 540; one or more bits that indicate that the input/output memory management unit (IOMMU) 310 has detected a process address space identifier (PASID)-selective priority descriptor 540 with a different domain-id and/or process address space identifier (PASID) than a currently in-progress process address space identifier (PASID)-selective priority descriptor 540; and/or that the input/output memory management unit (IOMMU) 310 detected that a new priority descriptor 540 with a levels field 552 set to 0 (e.g., a default level of priority), when there is no priority descriptor 540 in progress. Additionally or alternatively, a new priority descriptor 540 with a levels field 552 set to 0 (e.g., a default level of priority) may be treated as a no-operation (NOP) that is completed successfully.

### Example Embodiments

EXAMPLE EMBODIMENT 1. A system comprising:

a peripheral device accessible to a virtual machine via direct memory access (DMA) translated by an input/output memory management unit (IOMMU); and

a processing device to run the virtual machine and a virtual machine manager to manage the virtual machine, wherein the processing device comprises the IOMMU, and wherein the IOMMU is configurable to reserve a subset of resources of the IOMMU to the virtual machine based on a descriptor provided by the virtual machine manager.

EXAMPLE EMBODIMENT 2. The system of example embodiment 1, wherein the descriptor comprises a first field to identify the virtual machine to cause the IOMMU to reserve the subset of the resources of the IOMMU to the virtual machine.

EXAMPLE EMBODIMENT 3. The system of example embodiment 2, wherein the first field defines a domain identifier of the virtual machine.

EXAMPLE EMBODIMENT 4. The system of example embodiment 2, wherein the descriptor comprises a second field to identify an application running on the virtual machine to cause the IOMMU to reserve the subset of the resources of the IOMMU to the application running on the virtual machine.

EXAMPLE EMBODIMENT 5. The system of example embodiment 4, wherein the second field defines a process address space identifier (PASID) of the application.

EXAMPLE EMBODIMENT 6. The system of example embodiment 1, wherein the descriptor comprises a field to define a requested level of priority to cause the IOMMU to reserve the subset of the resources of the IOMMU to the virtual machine according to the requested level.

EXAMPLE EMBODIMENT 7. The system of example embodiment 1, wherein the IOMMU is configurable to stop reserving the subset of the resources of the IOMMU to the virtual machine based on a second descriptor provided by the virtual machine manager.

EXAMPLE EMBODIMENT 8. The system of example embodiment 7, wherein the second descriptor comprises a field that specifies that the second descriptor is a stop priority descriptor to the IOMMU to cause the IOMMU to stop reserving the subset of the resources of the IOMMU to the virtual machine.

EXAMPLE EMBODIMENT 9. The system of example embodiment 7, wherein the second descriptor comprises a field to define a requested level of priority, set to a lowest level of priority, to cause the IOMMU to stop

reserving the subset of the resources of the IOMMU to the virtual machine.

EXAMPLE EMBODIMENT 10. The system of example embodiment 1, wherein the subset of the resources of the IOMMU comprises cache resources of the IOMMU.

EXAMPLE EMBODIMENT 11. The system of example embodiment 1, wherein the peripheral device comprises a scalable input/output virtualization (SIOV) device or a single-root input/output virtualization (SR-IOV) device.

EXAMPLE EMBODIMENT 12. An article of manufacture comprising one or more tangible, non-transitory machine-readable media comprising instructions that, when executed by a processing device, cause the processing device to:

determine that first software interfacing with a peripheral device is running a critical workload; and

issue a priority descriptor to an input/output memory management unit (IOMMU) to cause the IOMMU to carry out a quality of service (QoS) policy that prioritizes the first software over second software.

EXAMPLE EMBODIMENT 13. The article of manufacture of example embodiment 12, wherein the instructions to determine that the first software is running a critical workload comprise instructions that, when executed by the processing device, cause the processing device to receive a user request to prioritize the first software over other software also interfacing with the peripheral device.

EXAMPLE EMBODIMENT 14. The article of manufacture of example embodiment 12, wherein:

the first software comprises a virtual machine running on the processing device; and

the instructions to determine that the first software is running the critical workload comprise instructions that, when executed by the processing device, cause the processing device to determine that the first software is running the critical workload when the virtual machine is undergoing migration.

EXAMPLE EMBODIMENT 15. The article of manufacture of example embodiment 12, wherein:

the first software comprises a non-virtualized application running on the processing device; and

the instructions to determine that the first software is running the critical workload comprise instructions that, when executed by the processing device, cause the processing device to determine, using an operating system of the processing device, that the first software is running the critical workload.

EXAMPLE EMBODIMENT 16. The article of manufacture of example embodiment 12, wherein the priority descriptor comprises:

a type field encoding a start of prioritization to the IOMMU; and

one or more fields identifying the first software.

EXAMPLE EMBODIMENT 17. The article of manufacture of example embodiment 16, wherein the one or more fields identifying the first software comprise:

a domain identifier field corresponding to the first software; and

a process address space identifier (PASID) corresponding to the critical workload.

EXAMPLE EMBODIMENT 18. The article of manufacture of example embodiment 12, wherein the priority descriptor comprises a priority level field to indicate a level of quality of service (QoS) policy to implement in the IOMMU.

EXAMPLE EMBODIMENT 19. An input/output memory management unit (IOMMU) to provide address translation to enable software to interact with a peripheral device, wherein the input/output memory management unit (IOMMU) comprises:

caching circuitry to cache data corresponding to address translation relating to the peripheral device; and

a capability register to identify that the input/output memory management unit (IOMMU) is configurable to reserve a subset of resources of the caching circuitry for specified software.

EXAMPLE EMBODIMENT 20. The input/output memory management unit (IOMMU) of example embodiment 19, wherein the caching circuitry comprises at least one of an input/output translation lookaside buffer (IOTLB), a context cache, a process address space identifier (PASID) cache, or a paging cache.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
a peripheral device accessible to a virtual machine via direct memory access (DMA) translated by an input/output memory management unit (IOMMU); and
a processing device to run the virtual machine and a virtual machine manager to manage the virtual machine, wherein the processing device comprises the IOMMU, and wherein the IOMMU is configurable to reserve a subset of resources of the IOMMU to the virtual machine based on a descriptor provided by the virtual machine manager.

2. The system of claim 1, wherein the descriptor comprises a first field to identify the virtual machine to cause the IOMMU to reserve the subset of the resources of the IOMMU to the virtual machine.

3. The system of claim 2, wherein the first field defines a domain identifier of the virtual machine.

4. The system of claim 2, wherein the descriptor comprises a second field to identify an application running on the virtual machine to cause the IOMMU to reserve the subset of the resources of the IOMMU to the application running on the virtual machine.

5. The system of claim 4, wherein the second field defines a process address space identifier (PASID) of the application.

6. The system of claim 1, wherein the descriptor comprises a field to define a requested level of priority to cause the IOMMU to reserve the subset of the resources of the IOMMU to the virtual machine according to the requested level.

7. The system of claim 1, wherein the IOMMU is configurable to stop reserving the subset of the resources of the IOMMU to the virtual machine based on a second descriptor provided by the virtual machine manager.

8. The system of claim 7, wherein the second descriptor comprises a field that specifies that the second descriptor is a stop priority descriptor to the IOMMU to cause the IOMMU to stop reserving the subset of the resources of the IOMMU to the virtual machine.

9. The system of claim 7, wherein the second descriptor comprises a field to define a requested level of priority, set to a lowest level of priority, and to cause the IOMMU to stop reserving the subset of the resources of the IOMMU to the virtual machine.

10. The system of claim 1, wherein the subset of the resources of the IOMMU comprises cache resources of the IOMMU.

11. The system of claim 1, wherein the peripheral device comprises at least one of a scalable input/output virtualization (SIOV) device and a single-root input/output virtualization (SR-IOV) device.

12. An article of manufacture comprising one or more tangible, non-transitory machine-readable media comprising instructions that, when executed by a processing device, cause the processing device to:
determine that first software interfacing with a peripheral device is running a critical workload; and
issue a priority descriptor to an input/output memory management unit (IOMMU) to cause the IOMMU to carry out a quality of service (QoS) policy that prioritizes the first software over second software.

13. The article of manufacture of claim 12, wherein the instructions to determine that the first software is running a critical workload comprise instructions that, when executed by the processing device, cause the processing device to receive a user request to prioritize the first software over other software also interfacing with the peripheral device.

14. The article of manufacture of claim 12, wherein:
the first software comprises a virtual machine running on the processing device; and
the instructions to determine that the first software is running the critical workload comprise instructions that, when executed by the processing device, cause the processing device to determine that the first software is running the critical workload when the virtual machine is undergoing migration.

15. The article of manufacture of claim 12, wherein:
the first software comprises a non-virtualized application running on the processing device; and
the instructions to determine that the first software is running the critical workload comprise instructions that, when executed by the processing device, cause the processing device to determine, using an operating system of the processing device, that the first software is running the critical workload.

16. The article of manufacture of claim 12, wherein the priority descriptor comprises:
a type field encoding a start of prioritization to the IOMMU; and
one or more fields identifying the first software.

17. The article of manufacture of claim 16, wherein the one or more fields identifying the first software comprise:
a domain identifier field corresponding to the first software; and
a process address space identifier (PASID) corresponding to the critical workload.

18. The article of manufacture of claim 12, wherein the priority descriptor comprises a priority level field to indicate a level of quality of service (QoS) policy to implement in the IOMMU.

19. An input/output memory management unit (IOMMU) to provide address translation to enable software to interact with a peripheral device, wherein the input/output memory management unit (IOMMU) comprises:
caching circuitry to cache data corresponding to address translation relating to the peripheral device; and
a capability register to identify that the input/output memory management unit (IOMMU) is configurable to reserve a subset of resources of the caching circuitry for specified software.

20. The input/output memory management unit (IOMMU) of claim 19, wherein the caching circuitry comprises at least one of an input/output translation lookaside buffer (IOTLB), a context cache, a process address space identifier (PASID) cache, or a paging cache.
